(19) United States
(12) Patent Application Publication
(10) Pub. No.: US 2024/0269024 A1
(43) Pub. Date: Aug. 15, 2024

(54) Patient Support Systems With Power Transfer Architecture

(71) Applicant: Stryker Corporation, Kalamazoo, MI (US)

(72) Inventors: Gwynneth St. John, Kalamazoo, MI (US); Aaron Douglas Furman, Kalamazoo, MI (US); Daniel V. Brosnan, Kalamazoo, MI (US); Zane Marwan Shami, Kalamazoo, MI (US); Scott Michael Batzer, Plainwell, MI (US)

(73) Assignee: Stryker Corporation, Kalamazoo, MI (US)

(21) Appl. No.: 18/569,863

(22) PCT Filed: Mar. 30, 2022
(86) PCT No.: PCT/US2022/022440

§ 371 Date: Dec. 13, 2023

Related U.S. Application Data
(60) Provisional application No. 63/237,292, filed on Aug. 26, 2021.
(60) Provisional application No. 63/237,296, filed on Aug. 26, 2021.
(60) Provisional application No. 63/237,298, filed on Aug. 26, 2021.

(51) Int. Cl. A61G 7/018; A61G 7/012; A61G 7/015; A61G 7/10

(52) U.S. Cl. CPC A61G 7/018; A61G 7/012; A61G 7/015; A61G 7/1001; A61G 7/1059; A61G 2203/10

(57) ABSTRACT

A patient transport apparatus including a base frame, an intermediate frame to provide support to a patient, an apparatus energy storage unit, an apparatus user interface, and an apparatus controller. The patient transport apparatus also includes a powered device having a module to perform a powered function, a device energy storage unit, a device user interface, a device interface adapted to cooperate with the apparatus interface to facilitate power transfer from the apparatus energy storage unit to the device energy storage unit, and a device controller. The device controller includes a power module configured to determine a charging level for the device energy storage unit based on a current state of the apparatus energy storage unit, and to draw power from the apparatus energy storage unit via the apparatus interface and across the device interface to charge the device energy storage unit at the charging level.

### CROSS-REFERENCE TO RELATED APPLICATIONS

The subject patent application claims priority to and all the benefits of U.S. Provisional Patent Application No. 63/237,292, filed on Aug. 26, 2021; U.S. Provisional Patent Application No. 63/237,296, filed on Aug. 26, 2021; and U.S. Provisional Patent Application No. 63/237,298, filed on Aug. 26, 2021; the disclosures of each of which are hereby incorporated by reference in their entirety.

### BACKGROUND

Patient support systems facilitate care of patients in a health care setting. Patient support systems comprise patient transport apparatuses such as, for example, hospital beds, stretchers, cots, tables, wheelchairs, chairs, stair chairs, and the like. Many conventional patient transport apparatuses, such as for example cots, generally include a base arranged for movement about floor surfaces, and a litter upon which a patient can be positioned or otherwise supported. Here, one or types of lift mechanisms may be employed to facilitate adjusting a vertical position of the litter relative to the base to, among other things, promote patient care, load the patient transport apparatus into an ambulance, and the like.

Conventional stair chairs (or “evacuation chairs”) are configured to facilitate transporting a seated patient up or down a flight of stairs, such as by employing tracks that allow for controlled descent down a staircase. Those having ordinary skill in the art will appreciate that, when used in connection with certain emergency medical services, stair chairs are typically realized as separate patient transport apparatuses from cots. Further, many conventional ambulances are configured to facilitate loading, securing, and transporting cots, but typically only employ storage space for stair chairs. Thus, in scenarios where a patient being transported via an ambulance on a cot must be transported up or down stairs using a stair chair, the patient sometimes has to be transferred between different patient transport apparatuses, such as from a stair chair to a cot which may subsequently be loaded into an ambulance.

Certain types of patient transport apparatus employ may employ or be configured to cooperate with various types of powered devices, modules, and the like, which may be used to assist caregivers in lifting/lowering the patient, moving the patient, or otherwise treating the patient. In addition, accessory devices, equipment, and the like also may utilize different powered devices, modules, and the like. Here, because these types of powered devices are typically configured for mobile use, rechargeable batteries are frequently employed to ensure that the powered devices perform as expected. However, depending on the specific configuration of the powered device, as well as the environment and conditions they are utilized in, battery charge can become depleted relatively quickly, which can complicate the process of carrying out patient care if, for example, certain powered devices need additional charging.

A patient support system designed to overcome one or more of the aforementioned challenges is desired.

### SUMMARY

The present disclosure is directed towards a patient support system with a patient transport apparatus including: a base frame arranged for movement about floor surfaces, an intermediate frame to provide support to a patient, a powered adjustment device, an apparatus energy storage unit, an apparatus user interface arranged for user engagement to selectively operate the powered adjustment device with power from the energy storage unit, an apparatus controller in electrical communication with the powered adjustment device, the apparatus energy storage unit, and the apparatus user interface, and an apparatus interface in communication with the apparatus controller. The system also includes a powered device including: a module to perform a powered function, a device energy storage unit, a device user interface arranged for user engagement to selectively operate the module with power from the device energy storage unit, a device interface in communication with the device controller, the device interface adapted to cooperate with the apparatus interface to facilitate power transfer from the apparatus energy storage unit to the device energy storage unit, and a device controller in electrical communication with the module, the device energy storage unit, and the device user interface, the device controller including a power module configured to determine a charging level for the device energy storage unit based on a current state of the apparatus energy storage unit, and to draw power from the apparatus energy storage unit via the apparatus interface and across the device interface to charge the device energy storage unit at the charging level.

The present disclosure is also directed towards a patient support system with a patient transport apparatus including: a base frame arranged for movement about floor surfaces, an intermediate frame to provide support to a patient, a powered adjustment device, an apparatus energy storage unit, an apparatus user interface arranged for user engagement to selectively operate the powered adjustment device with power from the energy storage unit, an apparatus controller in electrical communication with the powered adjustment device, the apparatus energy storage unit, and the apparatus user interface, and an apparatus interface in communication with the apparatus controller. The system also includes a first powered device including: a first module to perform a powered function, a first device energy storage unit, a first device user interface arranged for user engagement to selectively operate the first module with power from the first device energy storage unit, a first device interface in communication with the first device controller, the first device adapted to cooperate with the apparatus interface to facilitate power transfer from the apparatus energy storage unit to the first device energy storage unit, and a first device controller in electrical communication with the first module, the first device energy storage unit, and the first device user interface. The system also includes a second powered device including: a second module to perform a powered function, a second device energy storage unit, a second device user interface arranged for user engagement to selectively operate the second module with power from the second device energy storage unit, a second device interface in communication with the second device controller, the second device interface adapted to cooperate with the apparatus interface to facilitate power transfer from the apparatus energy storage unit to the second device energy storage unit, and a second device controller in electrical communication with the second module, the second device energy storage unit, and the second device user interface, where the first device controller includes a first power module configured to determine a first charging level for the first powered device based on a current state of the apparatus energy storage unit, and to draw power from the apparatus energy storage unit via the apparatus interface and across the first device interface to charge the first energy storage unit at the first charging level, where the second device controller includes a second power module configured to determine a second charging level for the second powered device based on the current state of the apparatus energy storage unit, and to draw power from the apparatus energy storage unit via the apparatus interface and across the second device interface to charge the second energy storage unit at the second charging level.

The present disclosure is also directed towards a patient support system with a patient transport apparatus including: a base frame arranged for movement about floor surfaces, an intermediate frame to provide support to a patient, a powered adjustment device, an apparatus energy storage unit, an apparatus user interface arranged for user engagement to selectively operate the powered adjustment device with power from the energy storage unit, an apparatus controller in electrical communication with the powered adjustment device, the apparatus energy storage unit, and the apparatus user interface, and an apparatus interface in communication with the apparatus controller, the apparatus interface including a transmit element to facilitate wireless power transfer. The system also includes a powered device including: a module to perform a powered function, a device energy storage unit, a device user interface arranged for user engagement to selectively operate the module with power from the device energy storage unit, a device interface including a receive element, the device interface in communication with the device controller and adapted to cooperate with the apparatus interface to facilitate wireless power transfer between the patient transport apparatus and the powered device, and a device controller in electrical communication with the module, the device energy storage unit, and the device user interface, the device controller including a power module configured to determine a charging level for the device energy storage unit based on a current state of the apparatus energy storage unit, and to wirelessly draw power from the apparatus energy storage unit via the apparatus interface and across the device interface to charge the device energy storage unit at the charging level.

The present disclosure is also directed towards a patient support system with a patient transport apparatus including: a base including a base frame arranged for movement about floor surfaces, an intermediate frame to provide support to a patient, a base lift device to adjust a height of the intermediate frame relative to the base frame, and a base energy storage unit, a litter adapted for releasable attachment to the intermediate frame of the patient transport apparatus, the litter including a litter energy storage unit and a plurality of articulable assemblies defining a patient support surface, a litter controller in electrical communication with the litter lift device and the litter energy storage unit, a base controller in electrical communication with the base lift device and the base energy storage unit a base interface in communication with the base controller, and a litter interface in communication with the litter controller, the litter interface adapted to cooperate with the base interface to facilitate power transfer from the base energy storage unit to the litter energy storage unit. The system also includes a powered device including: a module to perform a powered function, a device energy storage unit, a device interface in communication with the device controller, the device interface adapted to cooperate with at least one of the base interface and the litter interface to facilitate power transfer from at least one of the base energy storage unit and the litter energy storage unit to the device energy storage unit, and a device controller in electrical communication with the module and the device energy storage unit, the device controller including a power module configured to determine a charging level for the device energy storage unit based on a current state of at least one of the base energy storage unit and the litter energy storage unit, and to draw power from at least one of the base energy storage unit and the litter energy storage unit and across the device interface to charge the device energy storage unit at the charging level. Other versions of this aspect include corresponding computer systems, apparatus, and computer programs recorded on one or more computer storage devices, each configured to perform the actions of the methods.

present disclosure is also directed towards a patient support system for managing power allocation. The patient support system has a powered device including: a module to perform a powered function, a device energy storage unit, a device user interface arranged for user engagement to selectively operate the module with power from the device energy storage unit, a device controller in electrical communication with the module, the device energy storage unit, and the device user interface, and a device interface in communication with the device controller. The system also includes a patient transport apparatus including: a base frame arranged for movement about floor surfaces, an intermediate frame to provide support to a patient, a powered adjustment device, an apparatus energy storage unit, an apparatus user interface arranged for user engagement to selectively operate the powered adjustment device with power from the energy storage unit, an apparatus interface in communication with the apparatus controller, the apparatus interface adapted to cooperate with the device interface to facilitate power transfer from the apparatus energy storage unit to the device energy storage unit, and an apparatus controller in electrical communication with the device controller, the apparatus controller including a priority module configured to determine a priority level associated with the powered device, the priority level dictating whether the powered device receives power from the patient transport apparatus, and with the priority module being further configured to transfer power from the apparatus energy storage unit via the apparatus interface and across the device interface to charge the device energy storage unit based on the priority level.

The present disclosure is also directed towards a patient support system for managing power allocation. The patient support system has a first powered device including: a first module to perform a powered function, a first device energy storage unit, a first device user interface arranged for user engagement to selectively operate the first module with power from the first device energy storage unit, a first device controller in electrical communication with the first module, the first device energy storage unit, and the first device user interface, a first device interface in communication with the first device controller; a second powered device including: a second module to perform a powered function, a second device energy storage unit, a second device user interface arranged for user engagement to selectively operate the second module with power from the second device energy storage unit, a second device controller in electrical communication with the second module, the second device energy storage unit, and the second device user interface, a second device interface in communication with the second device controller. The system also includes a patient transport apparatus including: a base frame arranged for movement about floor surfaces, an intermediate frame to provide support to a patient, a powered adjustment device to adjust a height of the intermediate frame relative to the base frame, an apparatus energy storage unit, an apparatus user interface arranged for user engagement to selectively operate the powered adjustment device with power from the energy storage unit, an apparatus interface in communication with the apparatus controller, the apparatus interface adapted to cooperate with the device interface to facilitate power transfer from the apparatus energy storage unit to the device energy storage unit, and an apparatus controller in electrical communication with the device controller, the apparatus controller including a priority module configured to determine respective priority levels associated with the first and second powered devices, the priority levels dictating whether the first and second powered devices respectively receive power from the patient transport apparatus, and to transfer power from the apparatus energy storage unit via the apparatus interface and across the first and second device interfaces to respectively charge the first and second device energy storage units based on the respective priority levels of the first and second powered devices.

The present disclosure is also directed towards a patient support system for managing power allocation. The patient support system has a powered device including: a module to perform a powered function, a device energy storage unit, a device controller in electrical communication with the module and the device energy storage unit, and a device interface in communication with the device controller. The system also includes a patient transport apparatus including: a base including a base frame arranged for movement about floor surfaces, an intermediate frame to provide support to a patient, a base lift device to adjust a height of the intermediate frame relative to the base frame, and a base energy storage unit, a litter adapted for releasable attachment to the intermediate frame of the patient transport apparatus, the litter including a litter energy storage unit, a litter lift device, and a plurality of articulable assemblies defining a patient support surface, an apparatus controller including a litter controller in electrical communication with the litter lift device and the litter energy storage unit, a base controller in electrical communication with the base lift device and the base energy storage unit, a base interface in communication with the base controller, and a litter interface in communication with the litter controller, the litter interface adapted to cooperate with the base interface to facilitate power transfer from the base energy storage unit to the litter energy storage unit, where the apparatus controller is in electrical communication with the device controller, the apparatus controller including a priority module configured to determine respective priority levels for the powered device, the base lift device, and the litter lift device, the priority levels dictating whether the powered device, the base lift device, and the litter lift device respectively receive power from the base energy storage unit, and to transfer power to each of the powered device, the base lift device, and the litter lift device based on the respective priority levels.

present disclosure is also directed towards a patient support system with a powered device including: a module to perform a powered function, a device energy storage unit, a device user interface arranged for user engagement to selectively operate the module with power from the device energy storage unit, a device controller in electrical communication with the module, the device energy storage unit, and the device user interface, and a device interface in communication with the device controller. The system also includes a patient transport apparatus including: a base frame arranged for movement about floor surfaces, an intermediate frame to provide support to a patient, a powered adjustment device to adjust a height of the intermediate frame relative to the base frame, an apparatus energy storage unit, an apparatus user interface arranged for user engagement to selectively operate the powered adjustment device with power from the energy storage unit, an apparatus interface in communication with the apparatus controller, the apparatus interface adapted to cooperate with the device interface to facilitate power transfer from the apparatus energy storage unit to the device energy storage unit, and an apparatus controller in electrical communication with the device controller, the apparatus controller including an identification module configured to receive identity data from the powered device, to identify the powered device based on the identity data, and to transfer power from the apparatus energy storage unit via the apparatus interface and across the device interface to charge the device energy storage unit based on the identity data.

The present disclosure is also directed towards patient support system for managing power allocation. The patient support system has a first powered device including: a first module to perform a powered function, a first device energy storage unit, a first device user interface arranged for user engagement to selectively operate the first module with power from the first device energy storage unit, a first device controller in electrical communication with the first module, the first device energy storage unit, and the first device user interface, a first device interface in communication with the first device controller; a second powered device including: a second module to perform a powered function, a second device energy storage unit, a second device user interface arranged for user engagement to selectively operate the second module with power from the second device energy storage unit, a second device controller in electrical communication with the second module, the second device energy storage unit, and the second device user interface, a second device interface in communication with the second device controller. The system also includes a patient transport apparatus including: a base frame arranged for movement about floor surfaces, an intermediate frame to provide support to a patient, a powered adjustment device to adjust a height of the intermediate frame relative to the base frame, an apparatus energy storage unit, an apparatus user interface arranged for user engagement to selectively operate the powered adjustment device with power from the energy storage unit, an apparatus interface in communication with the apparatus controller, the apparatus interface adapted to cooperate with the device interface to facilitate power transfer from the apparatus energy storage unit to the device energy storage unit, and an apparatus controller in electrical communication with the device controller, the apparatus controller including an identification module configured to receive respective identity data from the first and second powered devices, to determine respective identification profiles associated with the first and second powered devices, and to control the transfer of power between the patient transport apparatus and one or more of the first powered device and the second powered device based on the respective identify data received from the first and second powered devices.

The present disclosure is also directed towards a patient support system with a powered device including: a module to perform a powered function, a device energy storage unit, a device controller in electrical communication with the module and the device energy storage unit, and a device interface in communication with the device controller. The system also includes a patient transport apparatus including: a base including a base frame arranged for movement about floor surfaces, an intermediate frame to provide support to a patient, a base lift device to adjust a height of the intermediate frame relative to the base frame, and a base energy storage unit, a litter adapted for releasable attachment to the intermediate frame of the patient transport apparatus, the litter including a litter energy storage unit, a litter lift device, and a plurality of articulable assemblies defining a patient support surface, an apparatus controller including a litter controller in electrical communication with the litter lift device, and the litter energy storage unit, a base controller in electrical communication with the base lift device and the base energy storage unit, a base interface in communication with the base controller, and a litter interface in communication with the litter controller, the litter interface adapted to cooperate with the base interface to facilitate power transfer from the base energy storage unit to the litter energy storage unit, where the apparatus controller is in electrical communication with the device controller and includes an identification module configured to receive identity data from the powered device, to identify the powered device based on the identity data, to determine an identification profile associated with the powered device based on the identity data, and to transfer power from the apparatus energy storage unit via the apparatus interface and across the device interface to charge the device energy storage unit based on the identity data.

### BRIEF DESCRIPTION OF THE DRAWINGS

FIG. 1A is a perspective view of a patient transport apparatus of a patient support system of the present disclosure, shown with the patient transport apparatus operating in an undocked mode with a base having stabilizers arranged in a deployed configuration to brace the base against floor surfaces for loading a litter, the litter shown positioned adjacent to the base and arranged in a chair configuration.

FIG. 1B is another perspective view of the patient transport apparatus of FIG. 1A, shown with the patient transport apparatus operating in a docked mode with the litter secured to the base and with the stabilizers arranged in a retracted configuration.

FIG. 2 is a schematic view of a control system of the patient transport apparatus of FIGS. 1A-1B.

FIG. 3A is a side view of the patient transport apparatus of FIGS. 1A-2, shown with the base arranged in a maximum lowered configuration and having a trolley disposed in a trolley docking position adjacent to the stabilizers shown in the deployed configuration, and with the litter arranged in the stair configuration adjacent to the stabilizers of the base.

FIG. 3B is another side view of the patient transport apparatus of FIGS. 1A-3A, shown with the litter positioned for engagement with the trolley of the base adjacent to the stabilizers.

FIG. 3C is another side view of the patient transport apparatus of FIGS. 1A-3B, shown with a rear assembly of the litter pivoting the litter relative to the trolley to transfer weight between the litter and the base.

FIG. 3D is another side view of the patient transport apparatus of FIGS. 1A-3C, shown with the litter operating in a cantilevered position where a front assembly and the rear assembly of the litter are pivoted off of the floor surface to transfer weight from the litter onto the base, the base shown braced via the stabilizers.

FIG. 3E is another side view of the patient transport apparatus of FIGS. 1A-3D, shown with the litter having moved with the trolley to a trolley forward position to place the patient transport apparatus in the docked mode MD.

FIG. 3F is another side view of the patient transport apparatus of FIGS. 1A-3E, shown operating in the docked mode, with the stabilizers moved to the retracted configuration, and with a fowler assembly of the litter shown arranged in a fowler lowered position.

FIG. 3G is another side view of the patient transport apparatus of FIGS. 1A-3F, shown operating in the docked mode, with the base arranged in a raised configuration.

FIG. 4A is another side view of the patient transport apparatus of FIGS. 1A-3G, shown positioned adjacent to a cargo area of an ambulance to which a power load device is secured, with the base of the patient transport apparatus shown arranged in a raised configuration.

FIG. 4B is another side view of the patient transport apparatus and the ambulance of FIG. 4A, shown with the base arranged in a lowered position secured to the power load device adjacent to the cargo area of the ambulance.

FIG. 4C is another side view of the patient transport apparatus and the ambulance of FIGS. 4A-4B, shown with the power load device retracted together with the patient transport apparatus into the cargo area of the ambulance.

FIG. 5 is a front perspective view of the litter of the patient transport apparatus of FIGS. 1A-4C.

FIG. 6 is a rear perspective view of the litter of the patient transport apparatus of FIGS. 1A-5.

FIG. 7A is a side view of the litter of the patient transport apparatus of FIGS. 1A-6, shown arranged in a loft configuration.

FIG. 7B is another side view of the litter of FIG. 7A shown transitioning between the loft configuration and the chair configuration.

FIG. 7C is another side view of the litter of FIGS. 7A-7B shown arranged in the chair configuration.

FIG. 7D is another side view of the litter of FIGS. 7A-7C shown arranged in a stair configuration.

FIG. 8 is another side view of the litter of FIGS. 7A-7D shown arranged in the stair configuration supporting a patient for transport along stairs.

FIG. 9 is an enlarged, partial side view of portions of the patient transport system of FIGS. 4A-4C, schematically depicting a plurality of power connections for transmitting power between energy storage units of different powered devices.

FIG. 10 is an illustrative schematic of a control system for the patient support system.

FIG. 11A is another illustrative schematic of the control system for the patient support system.

FIG. 11B is another illustrative schematic of the control system of the patient support system.

FIG. 12 is an illustrative schematic depicting aspects of power connections of the patient support system.

### DETAILED DESCRIPTION

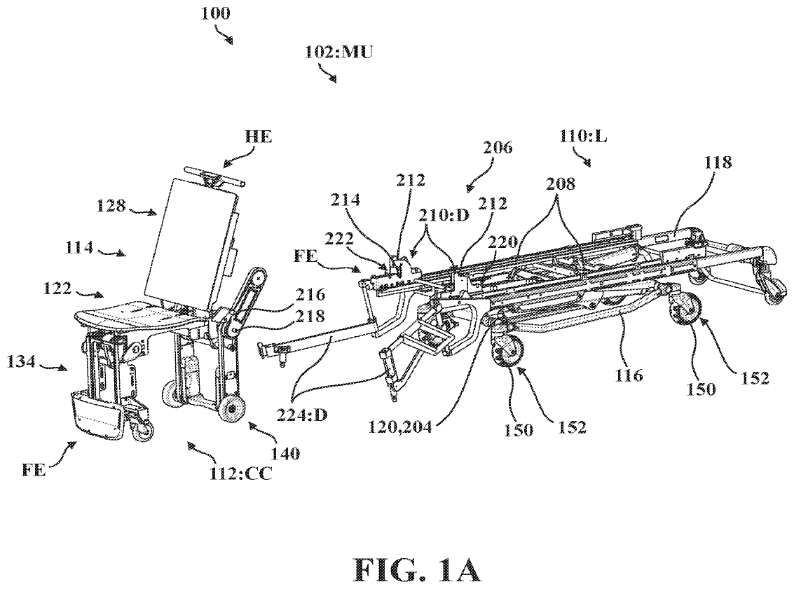

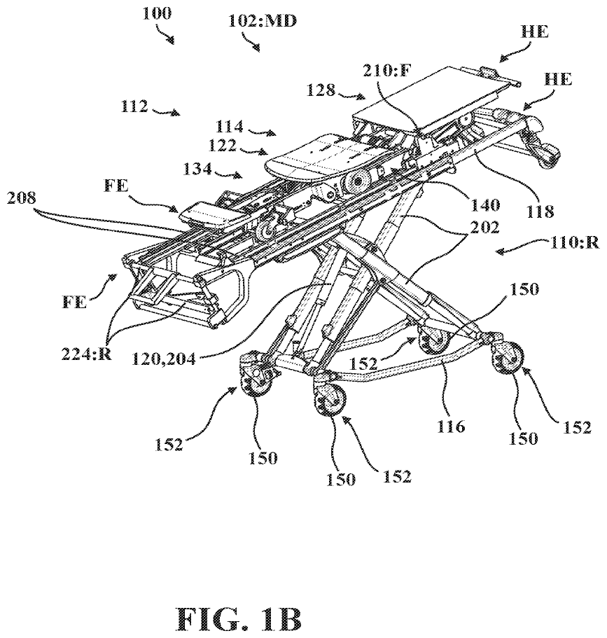

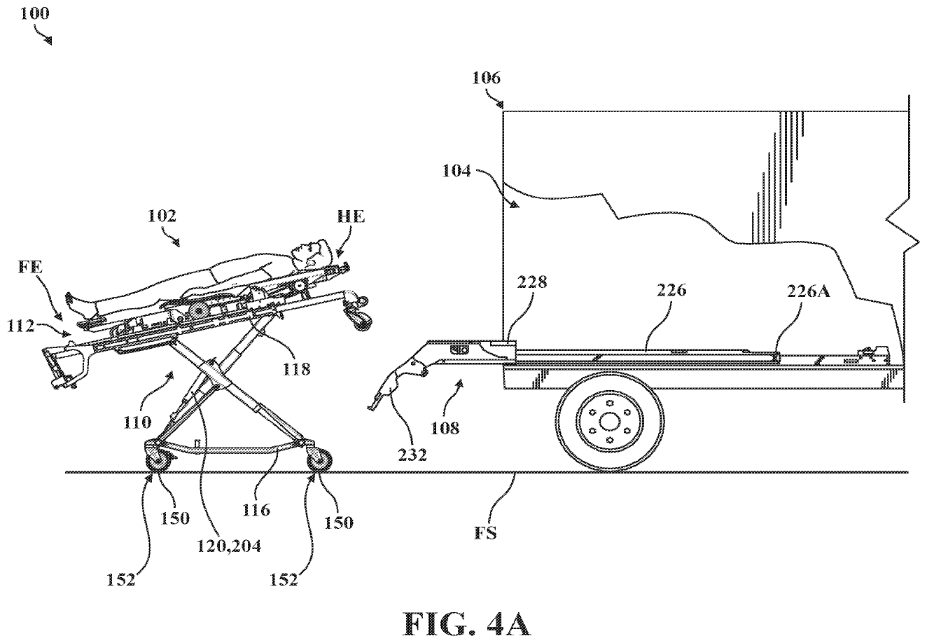

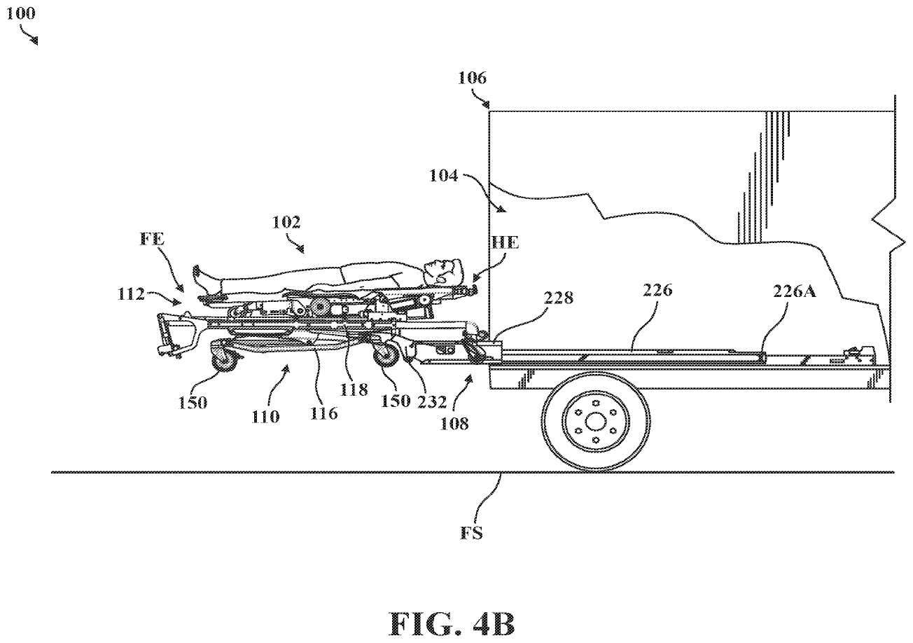

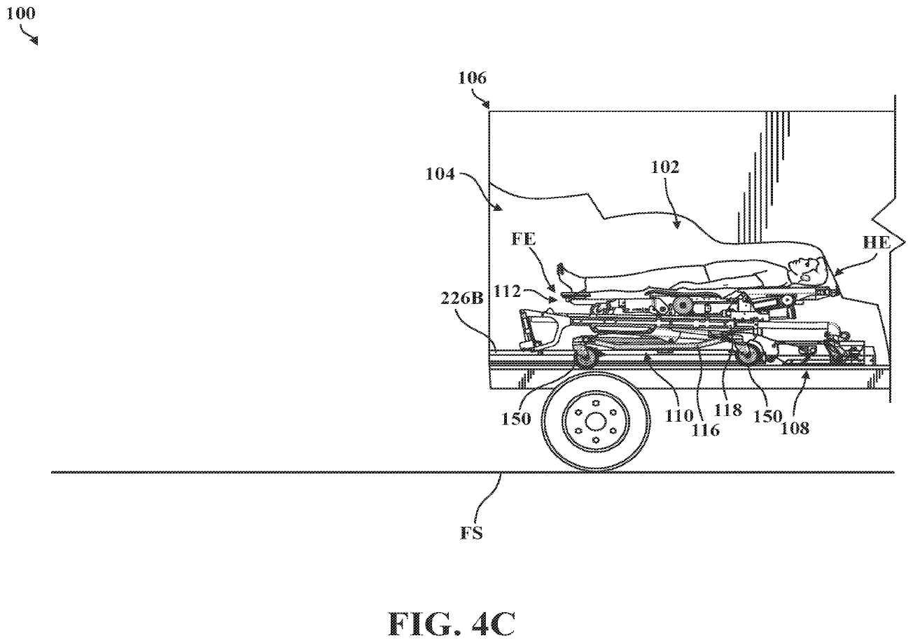

Referring to FIGS. 1A-1B and 4A, portions of a patient support system 100 are shown including a patient transport apparatus 102 for supporting a patient in a health care setting according to aspects of the present disclosure. In some versions, the patient transport apparatus 102 is configured to be loaded into a cargo area 104 of an ambulance 106, such as via a power load device 108 (see FIGS. 4A-4C). As will be appreciated from the subsequent description below, while the illustrated versions of the patient transport apparatus 102 described herein are configured as cots for transporting patients, the patient transport apparatus 102 may comprise a hospital bed, a stretcher, a table, a wheelchair, a chair, or a similar apparatus utilized in the care of a patient. The version of the patient transport apparatus 102 shown in FIGS. 1A-1B generally comprises a base 110 and a litter 112. The litter 112 defines or otherwise comprises a patient support surface 114 to support a patient.

In some versions, the patient transport apparatus 102 may comprise a reconfigurable patient support as described in U.S. Pat. No. 9,486,373, which is hereby incorporated by reference in its entirety. In some versions, the patient transport apparatus 102 may comprise a reconfigurable transport apparatus as described in U.S. Pat. No. 9,510,981, which is hereby incorporated by reference in its entirety. In some versions, the patient transport apparatus 102 may comprise a person support apparatus system as described in U.S. Patent Application Publication No. 2018/0028383, which is hereby incorporated by reference in its entirety. In some versions, the patient transport apparatus 102 may comprise a patient transfer apparatus with integrated tracks as described in U.S. patent application Ser. No. 15/854,943, which is hereby incorporated by reference in its entirety. In some versions, the patient transport apparatus 102 may comprise a variable speed patient transfer apparatus as described in U.S. patent application Ser. No. 15/854,199, which is hereby incorporated by reference in its entirety. In some versions, the patient transport apparatus 102 may comprise a patient transfer apparatus as described in U.S. patent application Ser. No. 15/855,161, which is hereby incorporated by reference in its entirety. In some versions, the patient transport apparatus 102 may comprise an ambulance cot as described in U.S. Pat. No. 7,398,571, which is hereby incorporated by reference in its entirety.

With continued reference to FIGS. 1A-1B, the base 110 and litter 112 each have a head end HE and a foot end FE corresponding to designated placement of the patient's head and feet on the patient transport apparatus 102. In FIG. 1A, the litter 112 is shown separated from the base 110; as is described in greater detail below, the base 110 is configured to removably receive and support the litter 112 in certain situations. Put differently, in the illustrated version, the litter 112 is configured for releasable attachment to the base 110. The base 110 generally includes a base frame 116, an intermediate frame 118, and a base lift device 120. The intermediate frame 118 is spaced above the base frame 116 and is moved relative to the base frame 116 via the base lift device 120 as described in greater detail below. Although not illustrated in detail in the drawings, a mattress (or sections thereof) may be disposed on or integral with the litter 112. In such circumstances, the mattress comprises or otherwise defines a secondary patient support surface 114 upon which the patient is supported.

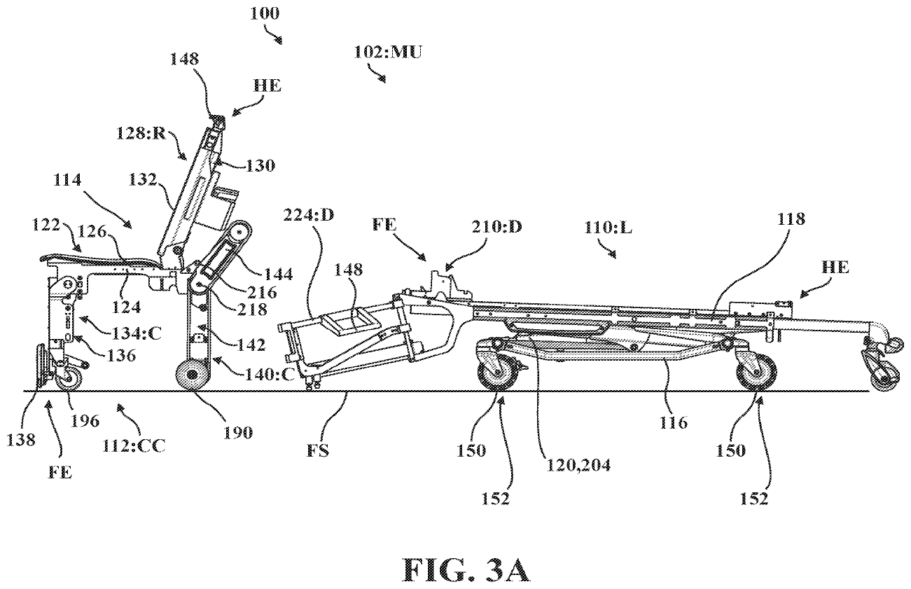

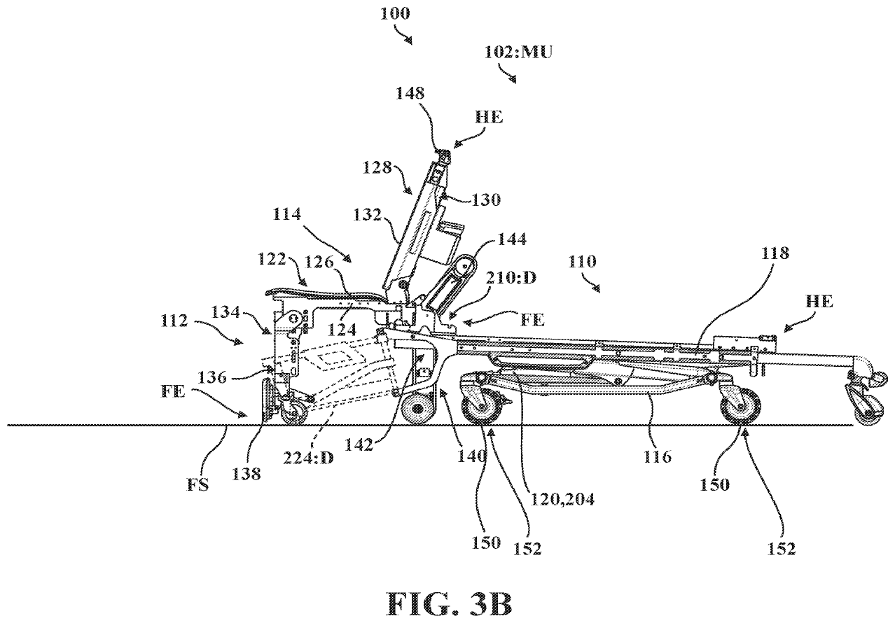

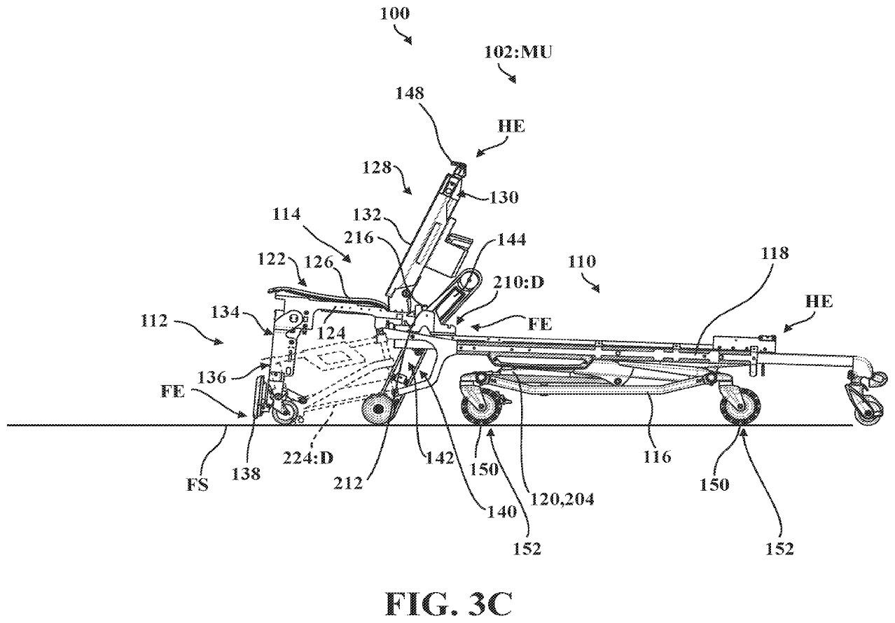

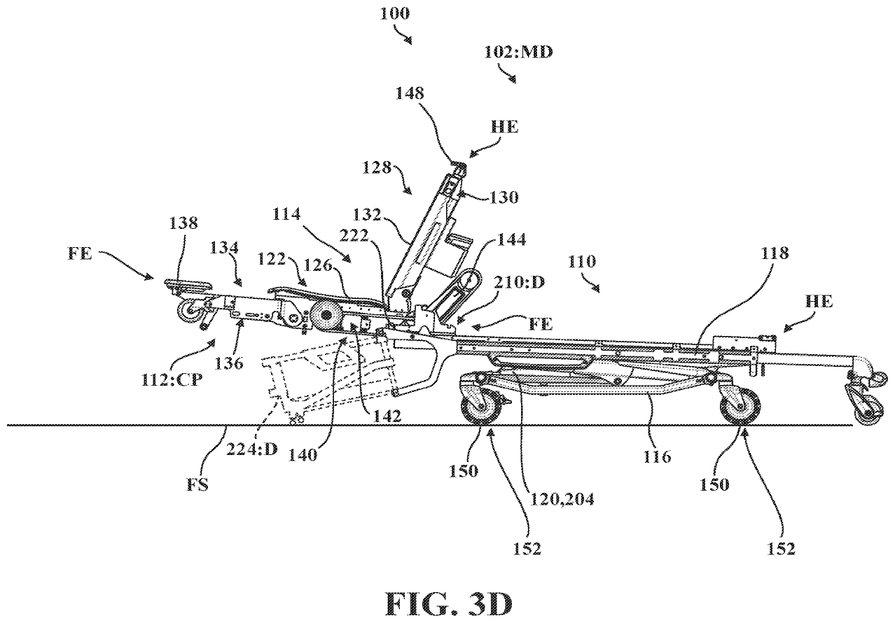

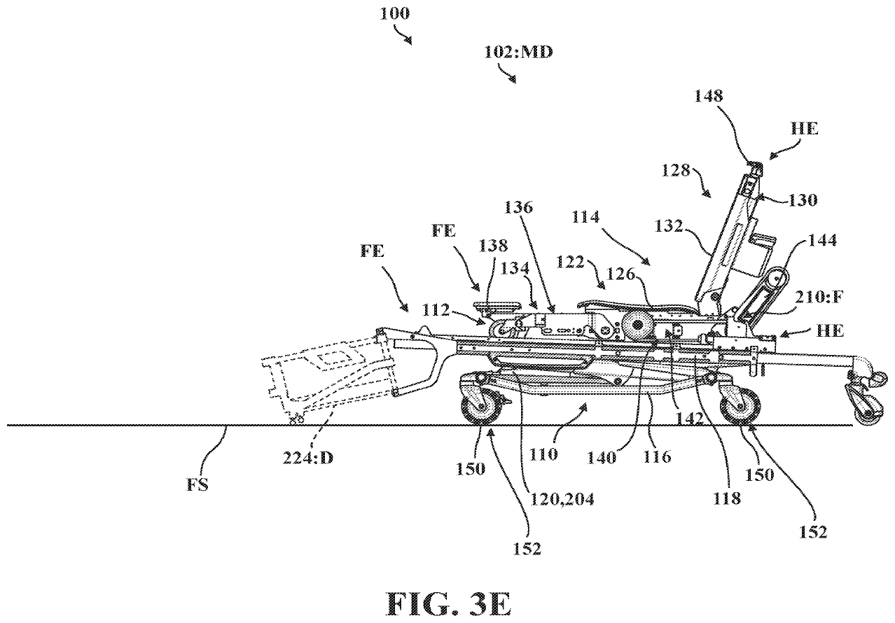

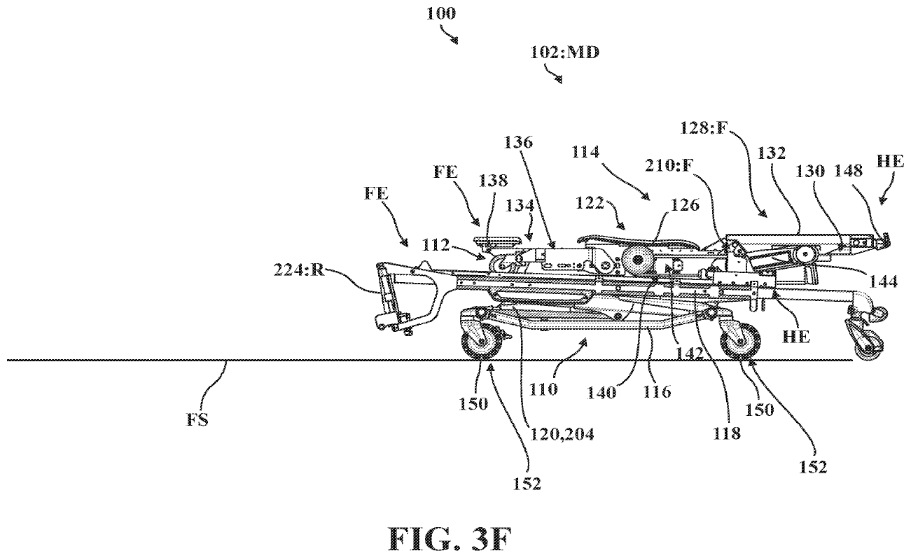

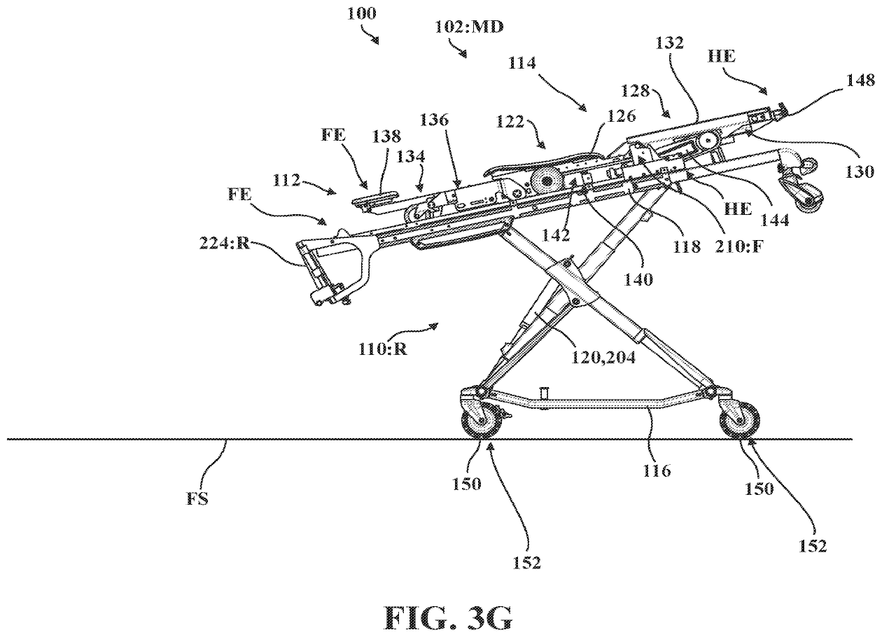

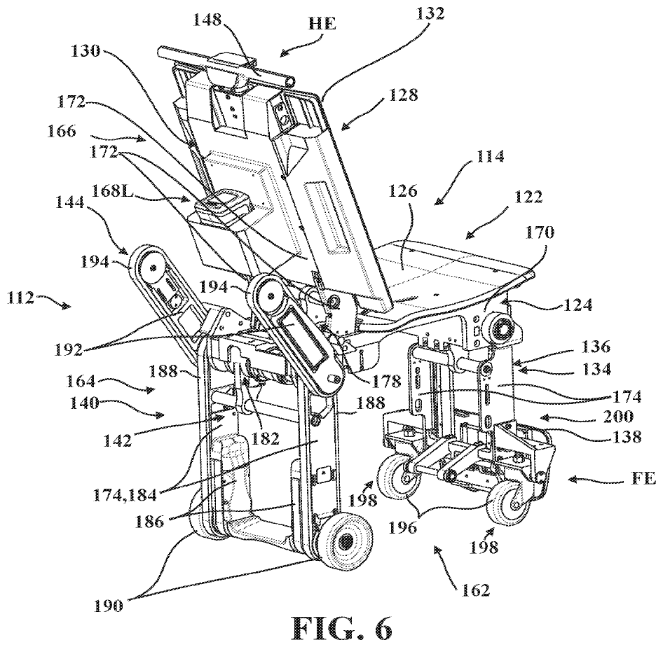

As will be described in greater detail below in connection with FIGS. 3A-8, in the illustrated versions, the litter 112 employs a plurality of assemblies, some of which are capable of being articulated relative to others in various ways and under certain operating conditions to adjust the patient support surface 114 and to facilitate docking to and undocking from the base 110. In the illustrated version, the litter 112 generally includes a seat assembly 122 with a seat frame 124 and a seat section 126, a fowler assembly 128 with a fowler frame 130 and a fowler section 132, a front assembly 134 with a front frame 136 and a front section 138, a rear assembly 140 with a rear frame 142, and a ski assembly 144. Each of the assemblies 122, 128, 134, 140, 144 introduced above will be described in greater detail below.

In the illustrated versions, the fowler assembly 128 pivots relative to the seat assembly 122 about a fowler axis XW, the front assembly 134 pivots relative to the seat assembly 122 about a front axis XF, and the rear assembly 140 pivots relative to the seat assembly 122 about a rear axis XR. In addition, the ski assembly 144 pivots about the rear axis XR as described in greater detail below, but could pivot about other axes in some configurations. In the illustrated version, the seat section 126, the fowler section 132, and the front section 138 each provide support to the patient and, thus, generally cooperate to define the patient support surface 114. In the illustrated version, the front section 138 is also configured to translate along the front frame 136, such as is described in U.S. patent application Ser. No. 16/705,878, the disclosure of which is hereby incorporated by reference in its entirety. It will be appreciated that the fowler section 132 and the front section 138 may pivot relative to the seat section 126, or may articulate relative to the seat section 126 in any manner. For instance, the fowler section 132 and/or the front section 138 may both pivot and translate relative to the seat section 126 in some configurations.

Caregiver interfaces 148, such as handles, help facilitate movement of the patient transport apparatus 102 over floor surfaces. Here, caregiver interfaces 148 may be coupled to the fowler assembly 128, the front assembly 134 (not shown), the intermediate frame 118, and the like. Additional caregiver interfaces 148 may be integrated into other components of the patient transport apparatus 102. The caregiver interfaces 148 are graspable by the caregiver to manipulate the patient transport apparatus 102 for movement.

Base wheels 150 are coupled to the base frame 116 to facilitate transport over floor surfaces. The base wheels 150 are arranged in each of four quadrants of the base 110 adjacent to corners of the base frame 116. In the illustrated versions, the base wheels 150 are caster wheels, which are able to rotate and swivel relative to the base frame 116 during transport. Each of the base wheels 150 forms part of a base caster assembly 152. Each base caster assembly 152 is mounted to the base frame 116. It should be understood that various configurations of base caster assemblies 152 are contemplated. In addition, in some configurations, the base wheels 150 are not caster wheels and may be non-steerable, steerable, non-powered, powered, or combinations thereof. Additional base wheels 150 are also contemplated. For example, the patient transport apparatus 102 may comprise four non-powered, non-steerable wheels, along with one or more powered wheels. In some cases, the patient transport apparatus 102 may not include any wheels. In other configurations, one or more auxiliary wheels (powered or non-powered), which are movable between stowed positions and deployed positions, may be coupled to the base frame 116. In some cases, when these auxiliary wheels are located between caster assemblies and contact the floor surface FS in the deployed position, they cause two of the base caster assemblies 152 to be lifted off the floor surface thereby shortening a wheel base 110 of the patient transport apparatus 102. A fifth wheel may also be arranged substantially in a center of the base 110. Other configurations are contemplated.

It should be noted that in many of the drawings described herein, certain components of the patient transport apparatus 102 have been omitted from view for convenience of description and ease of illustration.

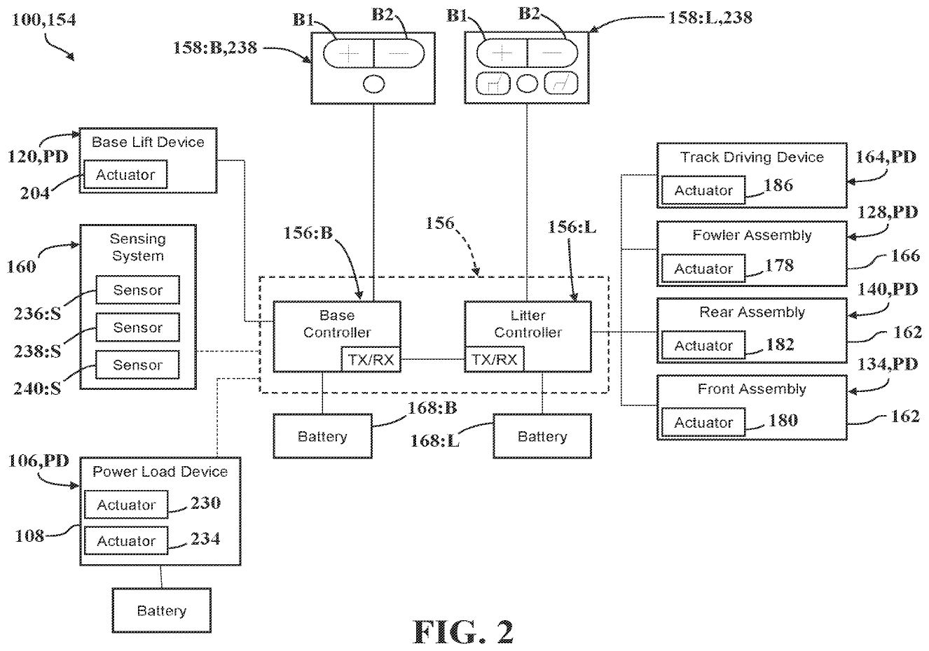

Referring now to FIG. 2, a control system 154 of the patient transport apparatus 102 is shown schematically. The control system 154 generally comprises one or more powered devices PD each having one or more modules M to perform powered functions, with the powered devices PD being configured for operated via one or more controllers 156. In some versions, the patient transport apparatus 102 employs a base controller 156B and/or a litter controller 156L (collectively referred to herein as “controller 156” and/or “apparatus controller 156A”) in response to actuation of one or more user interfaces 158. In some versions, the patient transport apparatus 102 includes a base user interface 158B and/or a litter user interface 158L (collectively referred to herein as “user interface 158” and/or “apparatus user interface 158A”) in response to state signals received from a sensing system 160. Each of these components will be described in greater detail below.

With continued reference to FIG. 2, each of the one or more powered devices PD of the control system 154 is configured to perform one or more predetermined functions. To this end, the powered devices PD employ one or more components that utilize electricity in order to perform functions. Additionally, or alternatively, the powered devices PD employ one or more modules configured to perform one or more powered functions. One or more powered devices PD of the patient support system 100 may include portions of the ambulance 106, the power load device 108, the patient transport apparatus 102, or other powered devices. The term “powered device PD” may also be utilized herein to refer to portions of the patient transport apparatus 102, such as the base 110 (e.g., the base lift device 120) and/or the litter 112 (e.g., a litter lift device 162, a track driving device 164, and a fowler section adjustment device 166 as described in greater detail below). To this end, various components, systems, and the like may utilize one or more energy storage units 168, such as batteries, capacitors, and the like. In some versions, the base 110 employs a base energy storage unit 168B and the litter 112 employs a litter energy storage unit 168L. The energy storage unit 168 (also referred to herein as a “battery”) provides power to components of the patient support system 100. It can be charged by wire energy transfer, short-distance wireless energy transfer, or a combination thereof. The energy storage unit 168, in combination with at least one of the base controller 156B and the litter controller 156L, can utilize power management technologies, supply regulation technologies, and charging system technologies for supplying energy to the components of the patient support system 100. Such technologies will be discussed in greater detail below. Other powered devices PD are also contemplated.

The powered devices PD may have many possible configurations for performing the predetermined functions of the patient transport apparatus 102. As will be appreciated from the subsequent description below, powered devices PD may cooperate with or otherwise form a part of the patient transport apparatus 102 in certain versions. Exemplary configurations of some of the powered devices PD are described in greater detail below. One or more actuators may be used to effectuate functions of each powered device PD. It should be understood that numerous configurations of the powered devices PD, other than those specifically described herein, are contemplated. Exemplary scenarios of how certain powered devices PD may be utilized are also described below. However, numerous other scenarios not described herein are also contemplated.

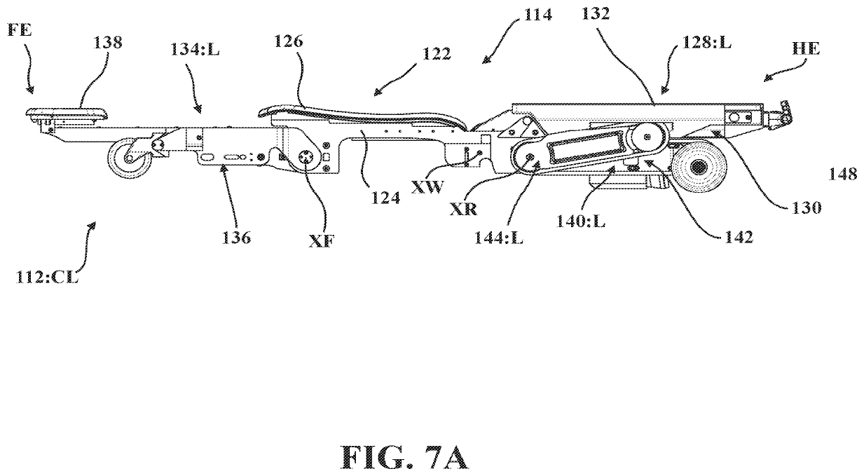

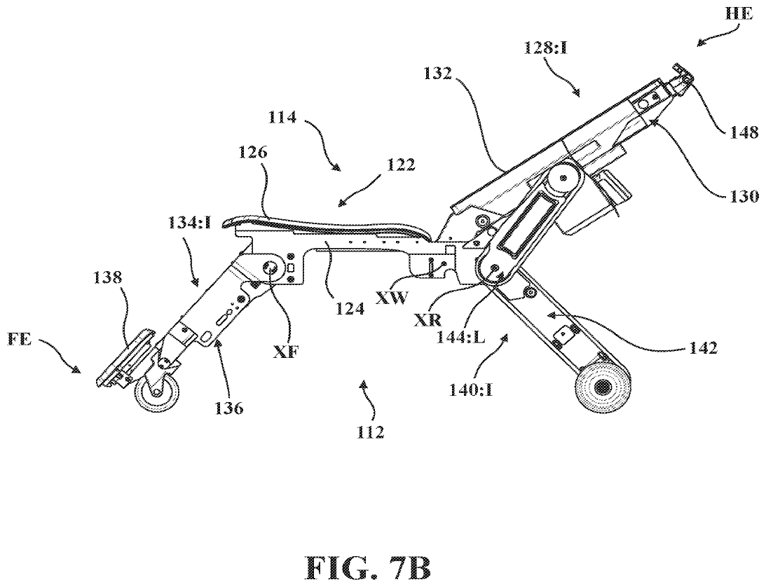

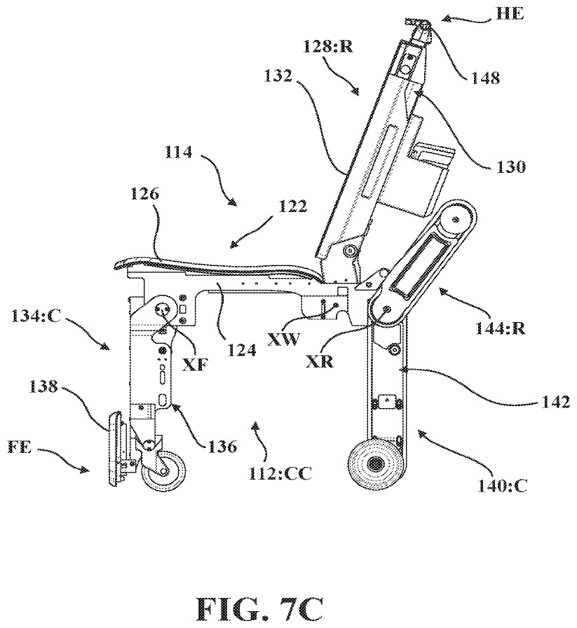

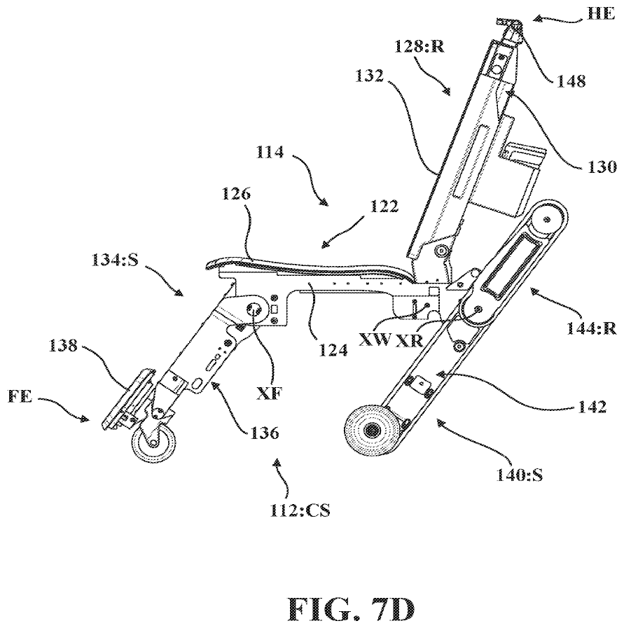

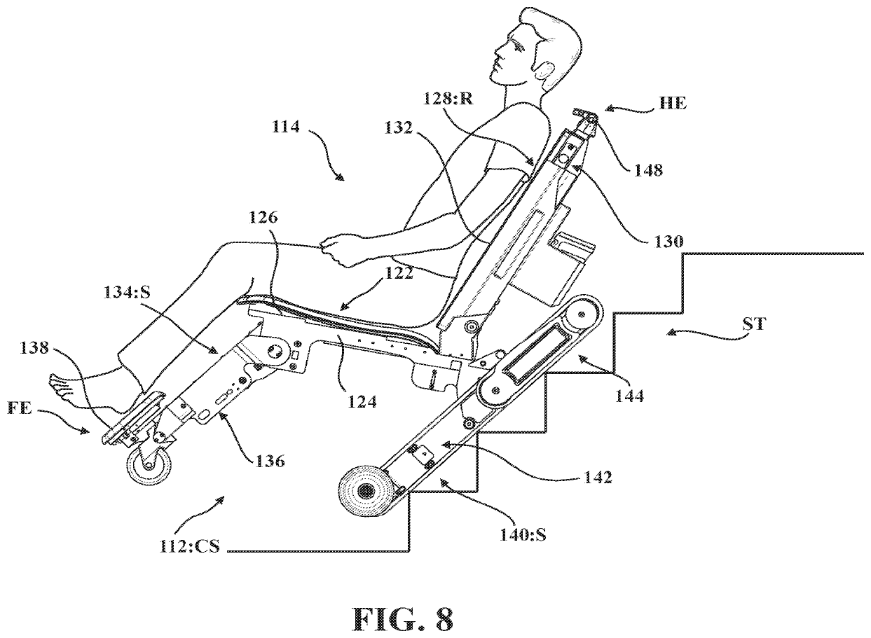

The litter 112 of the present disclosure is configured to be removably attached to the intermediate frame 118 of the base 110, as noted above and as is described in greater detail below, and is generally operable between: an undocked mode MU (see FIG. 1A) where the litter 112 supports the patient for movement independent of the base 110, and a docked mode MD (see FIG. 1B) where the litter 112 support the patient for movement concurrent with the base 110. The process of moving between the undocked mode MU and the docked mode MD is described in greater detail below in connection with FIGS. 3A-3G. While operating in the undocked mode MU, the litter 112 is operable between a loft configuration CL (see FIG. 7A), a chair configuration CC (see FIG. 7C), and a stair configuration CS (see FIGS. 7D-8). While operating in the docked mode MD, portions of the litter 112 may be articulable to adjust the patient support surface 114, such as by moving the fowler assembly 128. Other configurations are contemplated.

In the version shown in FIGS. 7C-8, when operating in and between the chair and stair configurations CC, CS, the litter 112 is configured to serve as a mobile chair to transport the patient along floor surfaces FS as well as up and down stairs ST. Mobile chairs (sometimes called “stair chairs”) are used to evacuate patients from buildings where patient accessibility is limited, such as buildings having more than one floor. As noted above, the patient support surface 114 of the litter 112 of the illustrated patient transport apparatus 102 is generally defined by the fowler section 132, the seat section 126, and the front section 138. Here, the seat section 126 is supported by the seat frame 124, and the fowler section 132 is supported by the fowler frame 130 that is coupled to the seat frame 124 such that the fowler frame 130 may pivot or otherwise articulate relative to the seat frame 124. The front section 138 is supported by the front frame 136 which is coupled to the seat frame 124 such that the front frame 136 may pivot or otherwise articulate relative to the seat frame 124. Here too, the rear assembly 140 is coupled to the seat frame 124 such that the rear frame 142 may pivot or otherwise articulate relative to the seat frame 124.

In some configurations, the seat frame 124 may include seat frame members 170 spaced laterally apart from and fixed relative to each other. Similarly, the fowler frame 130 may include fowler frame members 172 spaced laterally apart and fixed relative to each other. The front frame 136 may include front legs 174 spaced laterally apart and fixed relative to each other, and the rear frame 142 may include rear legs 176 spaced laterally apart and fixed relative to each other. In the illustrated version, the litter 112 comprises a fowler actuator 178, a front actuator 180, and a rear actuator 182 which are each driven by the controller 156 (e.g., by the litter controller 156L) and are operatively attached to the seat assembly 122 to facilitate respectively pivoting or otherwise articulating the fowler assembly 128, the front assembly 134, and the rear assembly 140 relative to the seat assembly 122.

In the illustrated versions, the fowler assembly 128 is movable via the fowler actuator 178 between a fowler raised position 128R (see FIGS. 7D-7E), a fowler lowered position 128L (see FIG. 7A), and one or more intermediate fowler positions 1281 (see FIG. 7B) between the fowler raised position 128R and the fowler lowered position 128L.

As noted above, the illustrated patient transport apparatus 102 employs the track driving device 164, which is configured to assist users in traversing a flight of stairs ST by mitigating the load users (e.g., caregivers) would otherwise be required to lift via caregiver interfaces 148 (see FIG. 8; not shown in detail). In some configurations, the track driving device 164 may be configured to move the litter 112 across the floor surface FS (not shown). The track driving device 164 is formed as a part of the rear legs 176 of the rear assembly 140. Here, each rear leg 176 includes a respective track frame member 184 coupled to the seat frame 124 for pivoting movement about the rear axis XR. The track driving device 164 also includes track actuators 186 which drive continuous leg tracks 188 rotatably coupled to the respective leg track frame members 184. The track actuators 186 are coupled to the track frame members 184 and are coupled to (or otherwise disposed in communication with) the controller 156 to drive the leg tracks 188 for ascending and descending stairs ST (see FIG. 8). The track driving device 164 may be configured to operate in the same manner or a similar manner as those shown in U.S. Pat. Nos. 7,398,571, 9,486,373, 9,510,981, and/or U.S. Patent Application Publication No. 2018/0028383, previously referenced.

The rear assembly 140 also includes rear wheels 190 rotatably coupled to each of the track frame members 184 that are configured to be disposed in contact with the floor surface FS, such as to support the litter 112 for movement in the chair configuration CC. In the illustrated versions, the rear wheels 190 are freely rotatable. In alternative versions, the rear wheels 190 may be powered drive wheels coupled to the controller 156. Other configurations are contemplated. The components of the track driving device 164 are arranged such that the leg track frame members 184, the leg tracks 188, and the rear wheels 190 move together with the rear assembly 140 which, as noted above, is arranged to selectively pivot about the rear axis XR to facilitate changing between the various configurations of the litter 112 as well as to facilitate docking and undocking from the base 110. As will be described in greater detail below, the rear assembly 140 is movable via the rear actuator 182 between a rear assembly loft position 140L (see FIG. 7A), a rear assembly chair position 140C (see FIG. 7C), a rear assembly stair position 140S (see FIGS. 7D-8), a rear assembly dock position 140D (see FIG. 3D), and one or more intermediate rear assembly positions 140I (see FIG. 7B) between the rear assembly loft position 140L and the rear assembly dock position 140D.

In some versions, the ski assemblies 144 serve as extensions to the track driving device 164 and likewise help facilitate engagement with stairs ST. To this end, in the illustrated versions, the ski assemblies 144 each include respective ski track frame members 192 operatively attached to the seat frame 124 for pivoting movement about the rear axis XR (or another axis). Here too, the track actuators 186 drive continuous ski tracks 194 rotatably coupled to the respective ski track frame members 192. In some versions, the ski assemblies 144 are arranged for pivoting movement between a plurality of ski positions, including a raised ski position 144R (see FIGS. 7C-7D), a lowered ski position 144L (see FIG. 7A), and one or more intermediate ski positions 144I between the raised ski position 144R and the lowered ski position 144L (see FIG. 7B). In some versions, abutment with the fowler assembly 128 moves the ski assemblies 144. However, other configurations are contemplated.

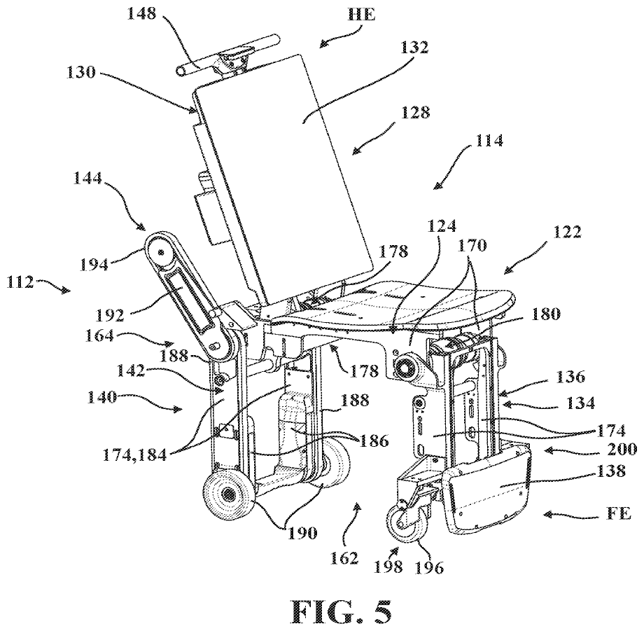

The front legs 174 of the front assembly 134 support respective front wheels 196, which are realized as part of respective front caster assemblies 198 arranged to facilitate movement of the litter 112 in the chair configuration CC (see FIGS. 5-6 and 7C), as well as to facilitate transitioning between the chair configuration CC and the stair configuration CS (compare FIGS. 7C-7D). In the illustrated versions, the front wheels 196 are freely rotatable, but could be motorized, braked, and the like in some versions. As noted above, in some versions, the front section 138 may be translatable along the front frame 136, such as when the litter 112 moves between the loft configuration CL and the chair configuration CC (compare FIGS. 7A-7D), and/or when the litter 112 operates in the docked mode MD (see FIG. 4A). To this end, the front assembly 134 may include an extension mechanism, generally indicated at 200, configured to longitudinally position the front section 138 relative to the front legs 174. While not depicted in detail herein, the extension mechanism 200 may be similar to as is described in U.S. patent application Ser. No. 16/705,878, the disclosure of which is incorporated by reference in its entirety. As will be described in greater detail below, the front assembly 134 is movable via the front actuator 180 between a front assembly loft position 134L (see FIG. 7A), a front assembly chair position 134C (see FIG. 7C), a front assembly stair position 134S (see FIGS. 7D-8), and one or more intermediate front assembly positions 1341 (see FIG. 7B) between the front assembly loft position 134L and the front assembly dock position 134D.

The litter lift device 162 is coupled to the litter 112 and is configured to raise and lower the patient between minimum and maximum heights of the litter 112, and to generally facilitate movement between the loft configuration CL, the chair configuration CC, and the stair configuration CS when the litter 112 is separated from the base 110 (see FIGS. 7A-7D). To this end, the illustrated litter lift device 162 generally includes the front actuator 180 and the rear actuator 182. The base lift device 120 is coupled to the base 110 and is configured to raise and lower the patient between a plurality of vertical configurations including a maximum raised configuration 110R (see FIG. 1B), a maximum lowered configuration 110L (see FIG. 1A), and a plurality of vertical configurations therebetween, both while the litter 112 is supported by the base 110 and, in some versions, while the litter 112 is undocked from the base 110.

In the representative version illustrated in FIGS. 1A-1B, the base 110 comprises one or more lift arms 202 coupling the intermediate frame 118 to the base frame 116. The base lift device 120 comprises one or more base lift actuators 204 coupled to at least one of the base frame 116 and the intermediate frame 118 to raise and lower the intermediate frame 118 and litter 112 relative to the floor surface FS and the base frame 116. The base lift device 120 may be configured to operate in the same manner or a similar manner as the lift mechanisms shown in U.S. Pat. Nos. 7,398,571, 9,486,373, 9,510,981, and/or U.S. Patent Application Publication No. 2018/0028383, previously referenced.

The base 110 of the patient transport apparatus 102 also generally includes a docking subassembly 206 operatively coupled to the intermediate frame 118. Here, the docking subassembly 206 includes intermediate rails 208 which support a trolley 210 for translation between a trolley forward position 210F where the trolley 210 is arranged at the head end HE of the base 110, and a trolley docking position 210D where the trolley 210 is arranged at the foot end FE of the base 110. The trolley 210 includes or otherwise defines upper and lower pin stops 212, 214 which are arranged to engage against respective upper and lower pins 216, 218 of the litter 112 in order to support the litter 112 in a cantilevered position CP during the process of docking the litter 112 to the base 110, as well as to support the litter 112 to the base 110 when operating in the docked mode MD. The docking subassembly 206 also generally includes a forward trolley lock mechanism 220 to inhibit movement of the trolley 210 away from the trolley forward position 210F, and a dock trolley lock mechanism 222 to inhibit movement of the trolley 210 away from the trolley docking position 210D, in order to facilitate transitioning between the undocked mode MU and the docked mode MD as described in greater detail below.

In the illustrated version, the base 110 also includes a stabilizer 224 operatively attached to the foot end FE of the intermediate frame 118 and configured for movement between a retracted configuration 224R (see FIGS. 3F-3G) where the stabilizer 224 is disposed in spaced relation from the floor surface FS, and a deployed configuration 224D (see FIGS. 3A-3E) where the stabilizer 224 engages the floor surface to brace the base 110 at an additional point of contact with the floor surface FS to stabilize the base 110 when the litter 112 is in the cantilevered position CP (see FIG. 3D) during the process of docking the litter 112 to the base 110.

As is shown in FIGS. 4A-4C and depicted schematically in FIG. 2, the power load device 108 is coupled to the ambulance 106 and is configured to load and unload the patient transport apparatus 102 into and out of the ambulance 106 when the power load device 108 is coupled to at least one of the litter 112 and the base 110. In this exemplary version, the power load device 108 of the patient support system 100 is realized as a powered device PD that can be driven by the controller 156 without necessarily forming a part of the patient transport apparatus 102. The power load device 108 generally comprises a rail 226 coupled to the ambulance. The rail 226 comprises a first rail end 226A at the back of the ambulance 106 where patients are loaded (e.g., the cargo area 104), and extends to a second rail end 226B toward the front of the ambulance 106.

The power load device 108 further includes a rail trolley 228 coupled to the rail 226. The rail trolley 228 is movable along a length of the rail 226. The power load device 108 also includes a trolley actuator 230 coupled to the rail 226 and the rail trolley 228 to move the rail trolley 228 along the length of the rail 226, and load arms 232 configured to pivot or otherwise articulate relative to the rail trolley 228 in order to support the patient transport apparatus 102 when at least one of the litter 112 and the base 110 are coupled to the rail trolley 228. The power load device 108 further includes an arm actuator 234 coupled to the rail trolley 228 and the load arms 232 to pivot or otherwise articulate the load arms 232 relative to the rail trolley 228. When the rail trolley 228 is coupled to at least one of the litter 112 and the base 110, the power load device 108 is coupled to or otherwise disposed in communication with the controller 156 to be controlled by the controller 156. The power load device 108 may be powered by a power source supplied by the ambulance 106 and/or by a power source on the patient transport apparatus 102. In some versions, the power load device 108 of the patient support system 100 is configured as described in U.S. Pat. No. 8,439,416, which is hereby incorporated by reference in its entirety.

As noted above, the control system 154 is provided to control operation of the one or more powered devices PD which form a part of or otherwise cooperate with the patient transport apparatus 102. To this end, the controller 156 may employ one or more microprocessors for processing instructions or an algorithm stored in memory to control operation of the one or more powered devices PD. Additionally or alternatively, the controller 156 may comprise one or more microcontrollers, field programmable gate arrays, systems on a chip, discrete circuitry, and/or other suitable hardware, software, and/or firmware that is capable of carrying out the functions described herein. The controller 156 may be carried on-board the patient transport apparatus 102, or may be remotely located. The controller 156 may comprise one or more subcontrollers configured to control the one or more powered devices PD, and/or one or more subcontrollers for each of the one or more powered devices PD. In some cases, one subcontroller may be attached to the litter 112 and another subcontroller may be attached to the base 110. Power to the one or more powered devices PD and/or the controller 156 may be provided by the energy storage unit 168. In alternative configurations, the one or more powered devices PD and/or the controller 156 may be provided by an external power source.

The controller 156 is coupled to the one or more powered devices PD in a manner that allows the controller to control the powered devices PD (e.g., via electrical communication). The controller 156 may communicate with the one or more powered devices PD via wired or wireless connections. In some versions, the controller 156 may generate and transmit control signals to the one or more powered devices PD, or components thereof, to drive or otherwise facilitate operating their associated actuators or to cause the one or more powered devices PD to perform one or more of their respective functions.

In addition to controlling operation of the one or more powered devices PD, in some versions, the controller 156 also determines current and desired states of the litter 112 and/or the base 110 based on input signals that the controller 156 receives from user interfaces 158 and/or based on state signals that the controller 156 receives from the sensing system 160. The state of the litter 112 and/or the base 110 may be a position, a relative position with respect to another object or component, an orientation, a configuration, an angle, a speed, a load condition, an energization status, or any other state of the litter 112 and/or the base 110.

The sensing system 160 comprises a state detection device 236 that is coupled to the litter 112 and the controller 156 and monitors the state of the litter 112 directly, or indirectly. The state detection device 236 comprises one or more sensors S configured to monitor the litter 112, the base 110, and/or the one or more powered devices PD. To this end, the state detection device generates a state signal corresponding to the state of the litter 112 and sends the state signal to the controller, such as when the litter 112 is mounted to the base 110.

The state detection device and/or other aspects of the sensing system 160 may be used by the controller for various purposes. The sensing system 160 may comprise one or more sensors S, including force sensors (e.g., load cells), timers, switches, optical sensors, electromagnetic sensors, motion sensors, accelerometers, potentiometers, infrared sensors, ultrasonic sensors, mechanical limit switches, membrane switches, encoders, and/or cameras. The sensing system 160 may further comprise one or more sensors S to detect mechanical, electrical, and/or electromagnetic coupling between components of the patient transport apparatus 102. Other types of sensors S are also contemplated. Some of the sensors S may monitor thresholds movement relative to discrete reference points. The sensors S can be located anywhere on the patient transport apparatus 102, or remote from the patient transport apparatus 102. For example, the sensors S may be located on or in the patient support surface 114, the base frame 116, the intermediate frame 118, or other suitable locations.

In some configurations, the sensing system 160 may act as an input device used to provide input signals to the controller 156 to cause or continue operation of the one or more powered devices PD. Numerous scenarios exist in which the one or more powered devices PD can be operated based on input signals provided by the sensing system 160 and/or the user interface 158.

In one configuration, the sensing system 160 indicates when the function being performed has been completed by the one or more powered devices PD. By way of non-limiting example, adjustment of one or more powered devices PD may be interrupted or stopped because a minimum or maximum position of the one or more powered devices PD has been reached, such as by using a sensor S realized as a mechanical limit switch, a membrane switch, and the like.

In certain versions, the sensing system 160 may include a state input device 238 to enable a user (e.g., a caregiver) to select a state such that actuation of the state input device 238 generates the state signal. In this case, instead of the controller 156 automatically detecting the current state SC of the litter 112, a user can manually enter the current state SC (or, in some versions, a desired state) of the litter 112 (e.g., “litter-on-base,” “litter-off-base,” etc.). In some configurations, the state input device 238 is spaced from at least one of the user interfaces 158. In other configurations, the state input device 238 is connected to at least one of the user interfaces 158.

One or more user interfaces 158 are coupled to the controller 156 and may be actuated by the user (e.g., a caregiver) to transmit corresponding input signals to the controller 156, and the controller 156 controls operation of the one or more powered devices PD based on the input signals and the state signals. Operation of the one or more powered devices PD may continue until the user discontinues actuation of the user interface 158, (e.g., until the corresponding input signal is terminated). Other configurations are contemplated.

The user interface 158 may comprise devices capable of being actuated by the user, and may be configured to be actuated in a variety of different ways, including but not limited to, mechanical actuation (hand, foot, finger, etc.), hands-free actuation (voice, foot, etc.), and the like. The user interface 158 may comprise one or more of a load cell, a push button, a touch screen, a joystick, a twistable control handle, a dial, a knob, a gesture sensing device for monitoring motion of hands, feet, face, or other body parts of the user (such as through a camera), a microphone for receiving voice activation commands, a foot pedal, and a sensor (e.g., infrared sensor such as a light bar or light beam to sense a user's body part, ultrasonic sensor, etc.). Additionally, buttons/pedals may be physical buttons/pedals, or may be virtually-implemented buttons/pedals such as through optical projection or forming part of a graphical user interface presented on a touchscreen. Buttons/pedals may also be mechanically-implemented in some versions, or may drive-by-wire type buttons/pedals where a user-applied force actuates a sensor S such as a switch or potentiometer. User interfaces 158 may be provided in one or more locations on the base 110 and/or the litter 112. Other configurations are contemplated.

In some versions of the patient transport apparatus 102, the user interface 158 may comprises two buttons B1, B2 that may be actuated to generate the input signal used by the controller 156 to drive the one or more powered devices PD. In other versions, the user interface 158 may comprise three or more buttons. In some versions, the user interface 158 may comprise a single button. Other configurations are contemplated.

As will be appreciated from the subsequent description below, individual buttons B, B (or “input controls”) of the user interface 158 may be used to control functions of or associated with more than one powered device PD. The user interfaces 158 generate input signals corresponding to each individual button B1, B2 of the user interface, when actuated. In order to operate different powered devices PD, the input signal received by the controller 156 may not change when the same button B1, B2 is actuated; rather, the state signals generated by the state detection device 236 may change according to the current state SC of the litter 112 and/or the base 110 such that the controller 156 determines which of the powered devices PD to actuate base 110d on the current state SC detected using the input signal from the same button B1, B2. Put differently, the same button B1, B2 can be used to control different powered devices PD depending on the state determined by the controller 156 via the sensing system 160, the state detection device 236, and/or the state input device 238. By way of non-limiting example, the user may actuate a button B1 on the user interface to operate the base lift device 120 when the litter 112 is in a first state, and the same button B1 may be actuated to operate the track driving device 164 when the litter 112 is in a second state. Other configurations are contemplated.

In one version, the sensing system 160 comprises a load detection device 240 coupled to the base 110. The load detection device 240 is configured to detect when the intermediate frame 118 is subjected to a load, such as load created by the litter 112 or load created by the litter 112 and the patient. More specifically, the load detection device 240 detects when a load has exceeded a load threshold. When the intermediate frame 118 is subject to a load below the load threshold, the base lift actuator 204 raises and lowers the intermediate frame 118 relative to the base frame 116 in response to actuation of the user interface 158 at a first rate. When the intermediate frame 118 is subjected to a load at or above the load threshold, the base lift actuator 204 raises and lowers the intermediate frame 118 relative to the base frame 116 in response to actuation of the user interface 158, at a second rate slower than the first rate. In the illustrated version, the base lift actuator 204 comprises a linear actuator. Here, the state detection device 236 comprises a sensor S to detect the litter 112 being coupled to and supported by the base 110. In this case, the current state SC of the litter 112 is considered to be a “litter-on-base” state. In response to detection via the sensor S, the state detection device 236 generates a corresponding state signal that is received by the controller 156; here in the “litter-on-base” state, when a user actuates the first button B1 of one of the user interfaces 158, the controller 156 is configured to operate the base lift actuator 204 to raise the litter 112 and the intermediate frame 118 relative to the floor surface and the base frame 116. Conversely, in the “litter-on-base” state, when the user actuates the second button B2 of the user interface 158, the controller 156 is configured to operate the base lift actuator 204 to lower the litter 112 and the intermediate frame 118 relative to the floor surface and the base frame 116. It will be appreciated that the forgoing represents examples of operation of the state detection device 236 and the state input device 238, and that other configurations are contemplated.

As noted above, the litter 112 is operable in the docked mode MD (see FIG. 1B) and in the undocked mode MU (see FIG. 1A). Referring now to FIG. 3A, when in the undocked mode MU the litter 112 may be disposed adjacent to the base 110, with the litter 112 placed in the chair configuration CC. Here, the chair configuration CC is defined by the fowler assembly 128 being in the fowler raised position 128R, the front assembly 134 being in the front assembly chair position 134C, and with the rear assembly 140 being in the rear assembly chair position 140C. More specifically, here in the chair configuration CC, the fowler raised position 128R places the fowler section 132 relative to the seat section 126 to support the patient in a seated configuration (not shown in detail). Here too, in the chair configuration CC, the front section 138 is arranged to abut the patient's legs, feet, and the like, and the front frame 136 is arranged substantially parallel to the rear frame 142 in a generally vertical configuration with the front wheels 196 and the rear wheels 190 engaging the floor surface FS. Here too in FIG. 3A, the base 110 is shown in the maximum lowered configuration 110L with the stabilizer 224 disposed in the deployed configuration 224D to brace the base 110, and with the litter 112 disposed at the foot end FE of the base 110. In this arrangement, the litter 112 is disposed adjacent to the base 110 and is positioned such as to begin the process of docking.

Continuing from FIG. 3A to FIG. 3B, the litter 112 is shown having been positioned longitudinally closer to the base 110, bringing the upper and lower pins 216, 218 into proximity of the trolley 210. Here, the sensing system 160 determines the relative positioning of the litter 112, and the controller 156 can be used to begin the process of docking by first actuating the rear actuator 182 to move the rear assembly 140 from the rear assembly chair position 140C towards the rear assembly dock position 140D in order to lower the upper and lower pins 216, 218 into engagement with the upper and lower pin stops 212, 214 of the trolley 210.

It will be appreciated that the arrangement of the rear assembly 140 as shown in FIG. 3C is such that the pivoting of the rear assembly 140 about the rear axis XR has moved the rear wheel 190 closer towards the front assembly 134 and has resulted in the seat assembly 122 having “tilted” backwards, which facilitates the process of transferring weight to the base 110. Here too, it will be appreciated that the rear assembly 140 is arranged for movement from the rear assembly chair position 140C (see also FIG. 7C) towards the rear assembly dock position 140D, as well as from the rear assembly chair position 140C towards the a rear assembly stair position 140S (see also FIG. 7D) when pivoting about the rear axis XR to move the rear wheel 190 closer towards the front assembly 134. However, the rear assembly 140 is also arranged for movement from the rear assembly chair position 140C (see also FIG. 7C) towards the rear assembly loft position 140L (see FIG. 7A) when pivoting about the rear axis XR to move the rear wheel 190 further away from the front assembly 134.

With continued reference to FIG. 3C, once the controller 156 has determined that the lower the upper and lower pins 216, 218 have come into engagement with the upper and lower pin stops 212, 214 of the trolley 210, the controller 156 drives the rear actuator 182 to pivot the rear assembly 140 about the rear axis XR until it reaches the a rear assembly dock position 140D and, at the same time, drives the front actuator 180 to pivot the front assembly 134 about the front axis XF from the front assembly chair position 134C to the front assembly loft position 134L as shown in FIG. 3D. Here, it will be appreciated that the rear actuator 182 and the front actuator 180 may be driven simultaneously by the controller 156.

In FIG. 3D, the litter 112 is shown disposed in the cantilevered position CP with the trolley 210 disposed in the trolley docking position 210D arranged at the foot end FE of the base 110. Here, the front assembly 134 and the rear assembly 140 are arranged generally parallel to each other and to the seat assembly 122. From this cantilevered position CP depicted in FIG. 3D, the dock trolley lock mechanism 222 can be disengaged by the user, and the trolley 210 can be moved to the trolley forward position 210F arranged at the head end HE of the base 110, as shown in FIG. 3E. Here, in FIG. 3E, the dock trolley lock mechanism 222 retains the trolley 210 in the trolley forward position 210F which places the patient transport apparatus 102 in the docked mode MD. At this point, the stabilizer can be moved to the retracted configuration 224R out of contact with the floor surface FS, and other portions of the patient transport apparatus 102 may be moved if needed, such as to move the fowler assembly 128 to the fowler lowered position 128L as shown in FIG. 3F and/or to raise the intermediate frame 118 to position the base 110 in the maximum raised configuration 110R as shown in FIG. 3G.

FIG. 4A shows the patient transport apparatus 102 in the docked mode MD and positioned adjacent to the cargo area 104 of the ambulance 106 for loading via the power load device 108. Here, the base 110 is arranged with the intermediate frame 118 raised relative to the base frame 116 near or slightly below the maximum raised configuration 110R in order to facilitate loading the patient transport apparatus 102 into the ambulance 106. Continuing to FIG. 4B from FIG. 4A, the patient transport apparatus 102 has been loaded onto the power load device 108 at the first rail end 226A of the rail 226. Here too in FIG. 4B, the base lift device 120 of the base 110 has been utilized to position the base 110 in the maximum lowered configuration 110L, which results in the base wheels 150 coming out of contact with the floor surface FS after weight from the patient transport apparatus 102 has been transferred to the power load device 108 via the load arms 232. At this point, the rail trolley 228 may be moved towards the second rail end 226B of the rail 226 as shown in FIG. 4C in order to load the patient transport apparatus 102 fully into the cargo area 104 of the ambulance 106.

Referring now to FIGS. 5-8, when operating in the undocked mode MU, the litter 112 can be placed in a number of different configurations to support the patient for movement independent of the base 110. In FIG. 7A, for example, the litter 112 is arranged in the loft configuration CL with the rear assembly 140, the front assembly 134, and the fowler assembly 128 each arranged generally parallel to the seat assembly 122 to support the patient in a flat configuration (e.g., laying down). Here in the loft configuration CL, the rear assembly 140 is in the rear assembly loft position 140L, the front assembly 134 is in the front assembly loft position 134L, the fowler assembly 128 is in the fowler lowered position 128L, and the ski assembly is in the lowered ski position 144L. From this position, the litter 112 can be moved into the chair configuration CC depicted in FIG. 7C by moving the front assembly 134 to the front assembly chair position 134C while also moving the rear assembly 140 to the rear assembly chair position 140C and the fowler assembly 128 to the fowler raised position 128R. Here, it will be appreciated that FIG. 7B depicts intermediate positions of the front assembly 134, the rear assembly 140, and the fowler assembly.

In the chair configuration CC depicted in FIGS. 5-6 and 7C, the rear assembly 140 and the front assembly 134 are each arranged parallel to each other and generally perpendicular to the seat assembly 122. From the chair configuration CC, the rear assembly 140 and the front assembly 134 can be moved simultaneously to bring the litter 112 into the stair configuration CS as depicted in FIG. 7D by placing the rear assembly 140 in the rear assembly stair position 140S and by placing the front assembly 134 in the front assembly stair position 134S. Here too in the stair configuration CS depicted in FIG. 7D, the front assembly 134 and the rear assembly 140 are arranged substantially parallel to each other, but are now arranged an oblique angle relative to the seat assembly 122 in order to, among other things, position the leg tracks 188 for engagement with stairs ST as shown in FIG. 8. Here in the stair configuration CS, the track driving device 164 can be used to move the litter 112 along stairs ST via engagement with the leg tracks 188 (as well as the ski tracks 194). It will be appreciated that the litter 112 can be moved between the configurations CL, CC, CS in various ways to facilitate patient care, and can be docked to and/or undocked from the base 110 as noted above.

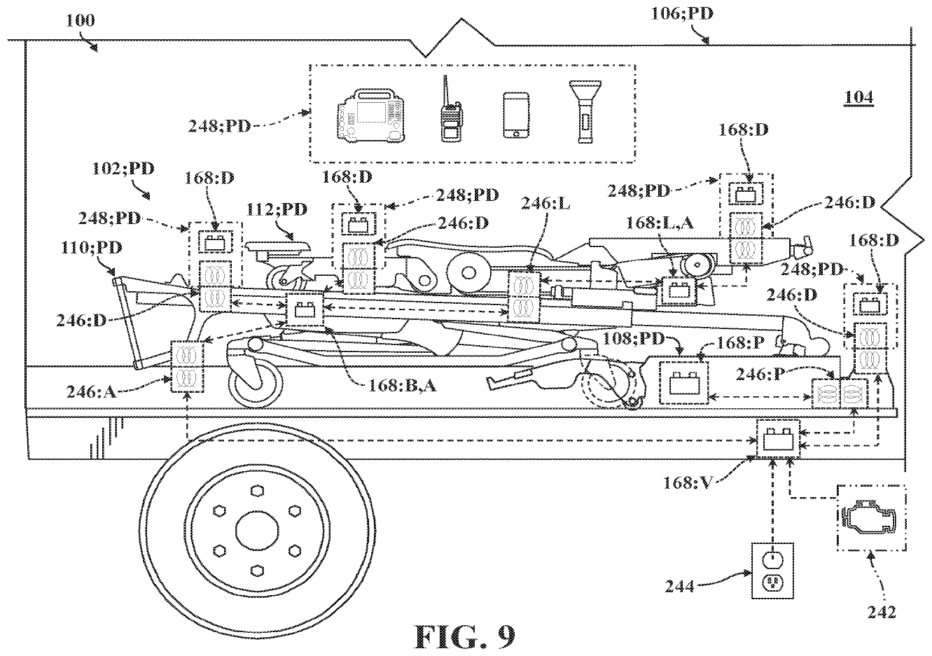

Referring now to FIG. 9, as noted above, the patient support system 100 employs the control system 154, one or more controllers 156, one or more user interfaces 158, one or more sensing systems 160, one or more energy storage units 168, and the like to facilitate controlling one or more powered devices PD, such as the power load device 108, the base lift device 120, the litter lift device 162, the track driving device 164, the fowler section adjustment device 166, and the like. In the illustrated version, the power utilized to facilitate operation of the powered devices PD is transferred to a vehicle energy storage unit 168B of the ambulance 106, such as from an internal combustion engine alternator 242, a mains power supply 244, and the like. The vehicle energy storage unit 168B of the ambulance 106, in turn, provides power that is used to operate other powered devices PD of the patient support system 100. To this end, one or more power connections 246 are employed to transfer power between different energy storage units 168 of different powered devices PD. For example, power from the vehicle energy storage unit 168V is transferred to the base energy storage unit 168B and/or the litter energy storage unit 168L across an apparatus power connection 246A to facilitate charging or otherwise powering, among other things, the base lift device 120. Here too, power from the vehicle energy storage unit 168V is transferred to a power load energy storage unit 168P used to power the power load device 108 (e.g., the arm actuator 234 described above) across a power load power connection 246P. Similar types of power connections 246 are described, for example, in U.S. Pat. No. 7,887,113, the disclosure of which is hereby incorporated by reference in its entirety. However, other configurations are contemplated.

As will be appreciated from the subsequent description below, various types of power connections 246 may be employed to facilitate physical electrical connections (e.g., electrical terminals which physically contact), wireless electrical connections (e.g., wireless power transfer), and the like with powered devices PD in order to facilitate power transfer, electrical communication, or combinations thereof. Furthermore, while not depicted in detail herein, power connections 246 may form a part of or otherwise include interlocking components configured to secure different components together physically (e.g., to secure the litter 112 to the base 110), to secure the patient transport apparatus 102 to the ambulance 106, and the like, to secure powered devices PD to each other or to other components or systems, and the like. Other configurations are contemplated.

With continued reference to FIG. 9, in the illustrated version, the vehicle energy storage unit 168 may also be configured to facilitate providing power to or otherwise charging one or more powered devices PD realized as accessory devices 248 across one or more device power connections 246D. Here, for example, accessory devices 248 may include Automated External Defibrillators, radios, portable electronic devices (e.g., cell phones, tablets, and the like), flashlights, heart monitors, pumps, and/or other types of powered devices PD that may be utilized by caregivers or other users during the course of patient treatment, transport, and/or care. Each powered device PD realized as an accessory device 248 may include a respective device energy storage unit 168D used to power a device controller 158D based on power received across one or more device power connections 246D.

In the illustrated version, a litter power connection 246L facilitates transferring power to the litter energy storage unit 168L from the base energy storage unit 168B. Here, in some versions, because the litter 112 is a powered device PD, it may be considered an accessory device 248 that is charged via the base energy storage unit 168B. However, while the litter 112 of the patient transport apparatus 102 illustrated throughout the drawings is removable from the base 110, it will be appreciated that other configurations are contemplated, such as where the litter 112 is not removably attached to the intermediate frame 118. Accordingly, in portions of the description below, the term “apparatus energy storage unit 168A” may be used to refer to the base energy storage unit 168B and/or the litter energy storage unit 168L. Similarly, the term “apparatus controller 156A” may be used to refer to the base controller 156B and/or the litter controller 156L; and the term “apparatus user interface 158A” may be used to refer to the base user interface 158B and/or the litter user interface 158L.

In the version shown in FIG. 9, a total of four device power connections 246D are shown: one coupled to the vehicle energy storage unit 168V, and three coupled to the apparatus energy storage unit 168A (more specifically, two coupled to the base energy storage unit 168B and one coupled to the litter energy storage unit 168L). Thus, it will be appreciated that the patient transport apparatus 102 could employ various arrangements of power connection 246, of various types, to facilitate charging, communicating with, controlling, and/or securing various types of powered devices PD (including but not limited to accessory devices 248).

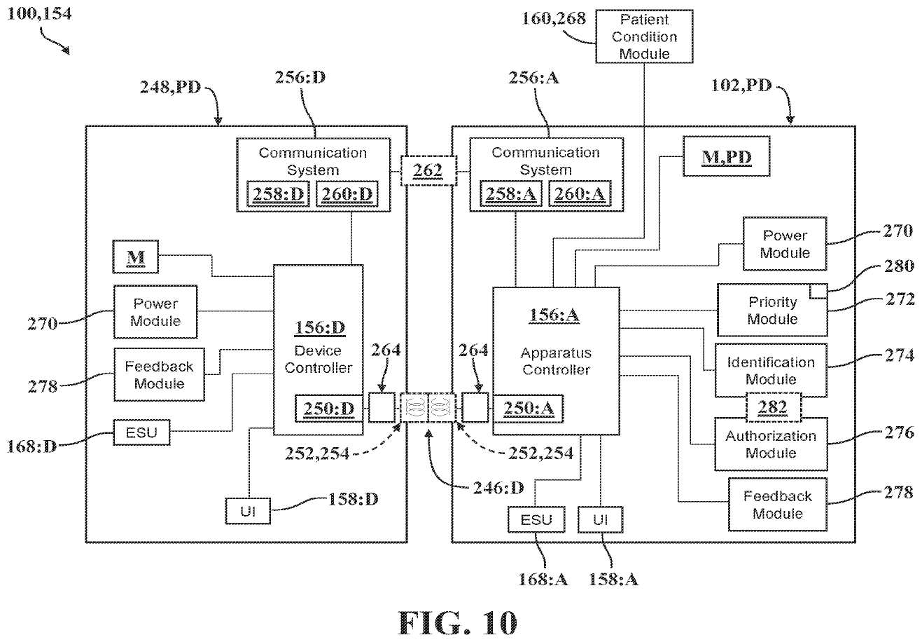

Referring now to FIG. 10, aspects of the patient support system 100 are shown schematically to depict communication and power transfer between two powered devices PD; specifically, from the patient transport apparatus 102 and one of the accessory devices 248 across one of the device power connections 246D. However, as will be appreciated from the subsequent description below, similar communication and power transfer may be effected between the ambulance 106 and other powered devices PD (e.g., the patient transport apparatus 102, the power load device 108, one or more accessory devices 238, and the like), between powered devices PD other than the ambulance 106 (e.g., between the base 110 and the litter 112, between the base 110 and one or more accessory devices 248, between the litter 112 and one or more accessory devices 248, and the like). Thus, while term “apparatus” generally refers to the patient transport apparatus 102 in this exemplary version, it will be appreciated that the term “apparatus” could also be substituted for terms referring defining whichever component, device, system, and/or portion of the patient support system 100 is supplying power to a particular powered device PD (e.g., an accessory device 248). Moreover, in some versions described herein, the term “apparatus” may generally refer to the base 110 of the patient transport apparatus 102, but other configurations are contemplated, and it will be appreciated that powered devices PD which are not necessarily supplied with power from the base energy storage unit 168B (either directly or indirectly) such as the power load device 108, and/or other components, devices, systems, and/or portions of the patient support system 100 which are “downstream” of the base 110 (e.g., accessory devices 248 coupled to the litter 112) may nevertheless be in communication with the base 110 or other controllers 156 of the patient support system 100.

In some versions, each powered device PD may include a respective interface 250 in communication with its controller 156 and/or energy storage unit 168 to facilitate power transfer across one of the power connections 246. In some versions, the interfaces 250 may include or otherwise define a transmit element 252 and/or a receive element 254; in instances where power is being transmitted by one powered device PD to another, the term “transmit element 252” is used herein to refer to whichever powered device PD is supplying power across the power connection 246, and the term “receive element 254” is used herein to review to refer to whichever powered device PD is receiving power across the power connection 246 from the transmit element 252.

As is described in greater detail below, in some versions, the transmit element 252 may be defined as a transmit coil 252, and the receive element 254 may be defined as a receive coil 254 configured to facilitate wireless power transfer across the power connection 246. However, other configurations are contemplated, and the transmit element 252 and/or receive element 254 could be defined in other ways (e.g., such as by physical electrical connections). Other configurations are contemplated. In some versions, each of the powered devices PD may also include a respective communication system 256 with a wireless subsystem 258 disposed in electrical communication with (or formed as a part of) its respective controller 156, and a wireless communication module 260 operable to wirelessly transfer data and to provide, through the wireless communication module 260, wireless communication between controllers 156 of powered devices PD of the patient support system 100.

With continued reference to FIG. 10, the device controller 156D of a powered device PD (e.g., an accessory device 248) is shown in electrical communication with the apparatus controller 156A (e.g., the base controller 156B and/or the litter controller 156L) and is coupled via a power connection 246 (e.g., a device power connection 246D). In some versions, or more powered devices PD may be operated directly or indirectly by the apparatus controller 156A in response to user engagement with various apparatus user interfaces 158A (e.g., the base user interface 158B and/or the litter user interface 158L) using power from the device energy storage unit 168D. In some versions, one or more of the powered devices PD may be operated by their respective device controllers 156D in response to user engagement with one or more device user interfaces 158D. Other configurations are contemplated.

With continued reference to FIG. 10, the patient transport apparatus 102 includes an apparatus interface 250A in communication with the apparatus controller 156A, and the powered device PD (e.g., an accessory device 248) includes a device interface 250D in communication with the device controller 156D. The powered device PD further includes a device communication system 256D having a device wireless subsystem 258D in electrical communication with the device controller 156D, and a device wireless communication module 260D operable to wirelessly transfer data and to provide, through the wireless communication module 260D, wireless communication between the device controller 156D and the apparatus controller 156A. Here too in FIG. 10, the patient transport apparatus 102 further includes an apparatus communication system 256A having an apparatus wireless subsystem 258A in electrical communication with the apparatus controller 156A, and an apparatus wireless communication module 260A operable to wirelessly transfer data and to provide, through the wireless communication module 260A, wireless communication between the apparatus controller 156A and the device controller 156D (and/or with other controllers 156 between the base controller 156B and/or the litter controller 156L).

In some versions, the wireless subsystems 258 may be defined as (or otherwise configured to operate according to protocols associated with) a controller area network CAN system, and the wireless communication modules 260 may be defined as (or be configured to operate according to protocols associated with) a Bluetooth device, such as a Bluetooth low energy BLE device. Such configurations may relate to or otherwise utilize a CAN-BLE network bridge, generally indicated at 262, for connecting a CAN bus and Bluetooth devices. To allow the base 110 and litter 112 to act as a fully integrated and connected system, and as is described in greater detail below, the CAN-BLE network bridge 262 may be utilized to transfer data between the base 110 and the litter 112 (and/or to other powered devices PD of the patient support system 100), as well as to help facilitate power transfer between the base 110 and the litter 112. Furthermore, the CAN-BLE network bridge 262 may also be utilized to facilitate transferring power and/or data between the patient transport apparatus 102 and/or other powered devices PD of the patient support system 100 (e.g., the ambulance 106, the power load device 108, the accessory devices 248, and the like). Here, data to be transmitted between controllers 156 may be realized as CAN messages that can be formatted, parsed, translated, and the like in order to facilitate passing data across wireless communication modules 260 (e.g., via BLE using the CAN-BLE network bridge 262), thereby allowing the base 110 to send data to the litter 112, and vice versa (as well as to allow other powered devices PD to exchange data).

Although the wireless subsystem 258 is realized as a CAN subsystem in the illustrated versions, those having ordinary skill in the art will appreciate that other types of subsystem, networks, and the like may be utilized. By way of non-limiting example, the wireless subsystem 258 may also be realized as one or more of a CANOpen network, a DeviceNet network, other networks having a CAN physical and data link layer, a local interconnect network LIN, or any other known subsystem and/or network for communicating messages between electronic structures of the patient support system 100, either via wireless communication and/or wired communication (e.g., with variously configured wired and wireless communication systems 256). The wireless subsystem 258 may employ separate controllers and/or internal nodes that are in communication with each other, such as by employing one or more microprocessors, microcontrollers, field programmable gate arrays, systems on a chip, volatile or nonvolatile memory, discrete circuitry, and/or other hardware, software, or firmware that is capable of carrying out the functions described herein, as would be known to one of ordinary skill in the art.

Although the wireless communication module 260 is configured to operate according to the BLE protocol in some versions, those having ordinary skill in the art will appreciate that other types of protocols are contemplated by the present disclosure (e.g., WiFi networking, near field communication NFC, radio frequency identification RFID, Qi standard communication, infrared communication, cellular networking, and the like). Thus, while not illustrated in detail herein, aspects of the wireless communication module 260, the wireless subsystem 258, and/or the communication system 256 may cooperate with or otherwise be realized as a part of the interfaces 250 and/or power connections 246 described herein (e.g., via transmit and receive elements 252, 254). Further, in order to transfer data, the wireless subsystems 258 and/or the wireless communication modules 260 of the communication systems 256 may use various methods, protocols, and/or standards including, but not limited to, Ethernet, Bluetooth, short message service SMS, multimedia messaging service MMS, and Web Services. To ensure data transfer is secure, the transferring of data may be done using a variety of security measures including, but not limited to, transport layer security TSL, secure sockets layer SSL, and virtual private network VPN. In some versions, messages and/or data may be encrypted (e.g., via the use of certificates, public key infrastructure PKI, and the like).

With continued reference to FIG. 10, as noted above, exemplary power transfer from the patient transport apparatus 102 to a powered device PD realized as an accessory device 248 is represented schematically. However, it will be appreciated that the components, structural features, configurations, and the like described herein and illustrated in connection with FIG. 10 could instead represent power transfer between other powered devices PD as noted above (e.g., between the base 110 and the litter 112, between the litter 112 and an accessory device 248, between the ambulance 106 and the patient transport apparatus 102, between the ambulance and an accessory device 248, and the like). Other configurations are contemplated. Nevertheless, in FIG. 10, the apparatus interface 250A is shown in communication with the apparatus controller 156A, and the device interface 250D is shown in communication with the device controller 156D of the accessory device 248. The device interface 250D is adapted to cooperate with the apparatus interface 250A to facilitate power transfer from the apparatus energy storage unit 168A to the device energy storage unit 168D across the device power connection 246D. In particular, the apparatus interface 250A includes a transmit element 252 and the device interface 250D includes a receive element 254 to facilitate power transfer between the patient transport apparatus 102 and the accessory device 248 (or to some other powered device PD). In some versions, power transfer is implemented using electrically-driven power transfer between the patient transport apparatus 102 and one or more powered devices PD. Specifically, electrically-driven power transfer may be implemented using inductive power transfer and/or capacitive power transfer. To implement these techniques, the accessory device 248 (or some other powered devices PD) is moved towards the patient transport apparatus 102 such that the device interface 250D is proximate to the apparatus interface 250A. Power may then be transferred to the accessory device 248 in response to inductive and/or capacitive interaction, as is described in greater detail below.

With inductive power transfer, the transmit element 252 is further defined as a transmit coil 252 and the receive element 254 is further defined as a receive coil 254. Inductive power transfer occurs from the transmit coil 252 to the receive coil 254. The transmit and receive coils 252, 254 are each electrical inductors and are operable together to form a transformer. As alternating current AC passes through the transmit coil 252, an electromagnetic field B is generated and passes through the receive coil 254. Upon wirelessly receiving the field B, the receive coil 254 induces alternating current AC. In some versions, one or more of the powered devices PD may include a receive circuit 264 for receiving the AC current induced via the receive coil 254. For example, the receive circuit 264 may be realized as a rectifier circuit for converting the alternating current AC into direct current DC suitable for utilization by the powered device PD and/or suitable to be stored in the energy storage unit 168. It will be appreciated that in configurations with coils, the transmit coil 252 generates the electromagnetic field B, while in other configurations, other types of fields are contemplated.

For the purposes of clarity and consistency, the term “inductive” used herein refers to the transferring power via coils. However, based on the similarities in inductive and capacitive wireless power transfer techniques, those skilled in the art will appreciate that the coils may be replaced with capacitive plates and/or other components to facilitate capacitive or other types of wireless power transfer. In other words, capacitive power transfer is fully contemplated for each of the versions described herein. It should be understood that the specific integration of the coils and/or specific geometries of the transmit and receive elements 252, 254 may differ between specific geometries and/or integration of the coils and plates. This is due to the nature of inductive power transfer requiring coils for proper operation and capacitive power transfer requiring plates for proper operation. To capture this commonality, the transmit and receive coils and/or plates are referred as transmit elements 252 and receive elements 254, respectively. Here, as noted above, the terms “transmit” and “receive” are contextual and are used to describe the direction in which power transfer occurs under certain operating conditions, such as to charge the litter energy storage unit 168L via power from the base energy storage unit 168B. However, it will be appreciated that each power connection 246 could have a respective transmit element 252 and a respective receive element 254, or could otherwise employ a single element that can both transmit power and receive power across the power connection 246. Other configurations are contemplated. Furthermore, as noted above, it is contemplated that power transfer across some or all of the power connections 246 may also be accomplished via wired electrical communication, whereby electrical terminals, contacts, and the like would then define the transmit and receive elements 252, 254. Thus, some or all of the power connections 246 described herein may be configured for wired and/or wireless power transmission.

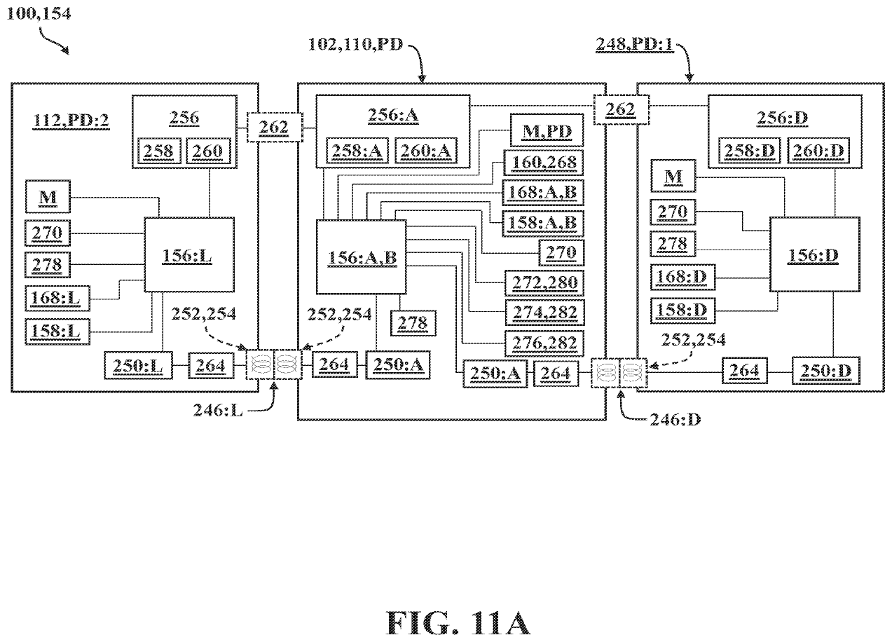

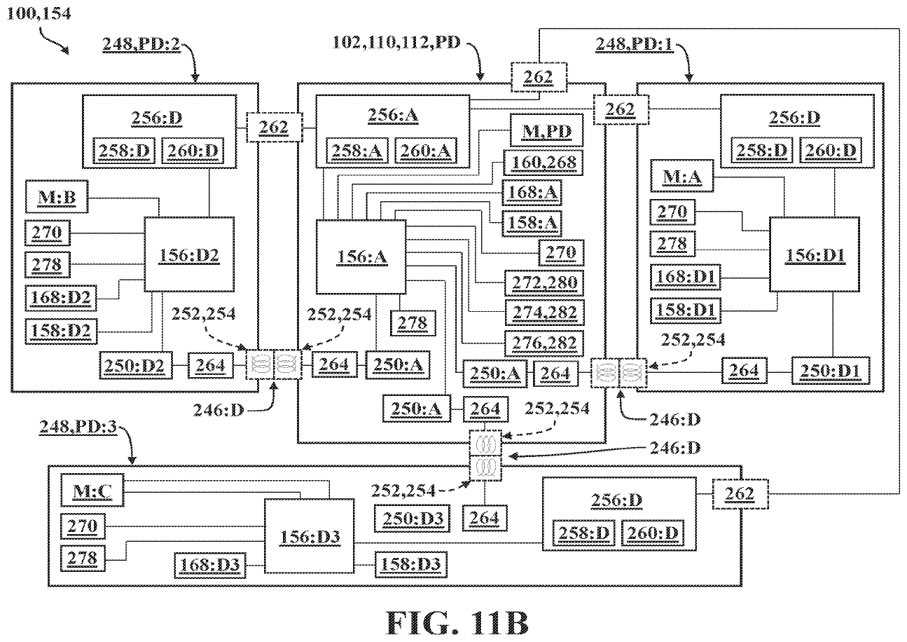

Referring now to FIGS. 11A-11B, as noted above, certain components of the patient support system 100 may be configured to provide power to multiple powered devices PD, such as where the ambulance 106 can provide power across the apparatus power connection 246A, the power load power connection 246P, the device power connection 246D; where the base 110 can provide power across the litter power connection 246L and/or multiple device power connections 246D, and the like. In the representative version depicted in FIG. 11A, the base 110 of the patient transport apparatus 102 is schematically depicted with a device power connection 246D to transfer power to a first powered device PD1 realized as an accessory device 248, and with a litter power connection 246L to transfer power to a second powered device PD2 realized as the litter 112. However, in FIG. 11B, the patient transport apparatus 102 is schematically depicted with three separate device power connections 246D to respectively transfer power to first, second, and third powered devices PD1, PD2, PD3 realized as separate accessory devices 248.

Similar to as is described above in connection with FIG. 10, those having ordinary skill in the art will appreciate that FIGS. 11A-11B schematically represent exemplary versions of how power can be transferred between different powered devices PD of the patient support system 100. Thus, it will be appreciated that the operation of aspects of the patient transport apparatus 102 described herein in connection with FIGS. 11A-11B could instead refer to other components of the patient support system with multiple power connections 246 that are configured to provide power to multiple powered devices PD. By way of non-limiting example, as shown in FIG. 9, the ambulance 106 provides power across the apparatus power connection 246A, the power load power connection 246P, and one or more device power connections 246D; the base 110 provides power across the litter power connection 246L and one or more device power connections 246D; and the litter 112 provides power across one or more device power connections 246D. Other configurations are contemplated.

With continued reference to FIGS. 11A-11B, each powered device PD may include one or more modules M to perform a powered function, and a respective user interface 158 arranged for user engagement to selectively operate its module(s) M with power from its energy storage unit 168. As noted above, it is contemplated that the patient support system 100 may include or otherwise cooperate with any number of powered devices PD. The powered devices PD may have many possible configurations for performing the predetermined functions of the patient transport apparatus 102 and/or predetermined functions of accessory devices 248. It is contemplated that one or more of the modules 266 may be realized as a part of, or otherwise define, certain powered device PD to perform certain powered functions. For example, where the powered device PD is an accessory device 248 realized as a defibrillator, the module M may include one or more of a screen, electrical circuitry, alarms, and/or indicators, and the like. Similarly, where the powered device PD is an accessory device 248 realized as a flashlight, the module M may include a light emitter (e.g., one or more light emitting diodes LEDs). Furthermore, where the powered device PD is realized as the base 110, the module M may include the one or more base lift actuators 204 of the base lift device 120. Where the powered device PD is realized as the litter 112, the module M may include the fowler actuator 178 of the fowler section adjustment device 166, the track actuators 186 of the track driving device 164, and/or the front and rear actuators 180, 182 of the litter lift device 162. Where the powered device PD is realized as the power load device 108, the module M may include the trolley actuator 230 and/or arm actuator 234 of the power load device 108. Here too, it will be appreciated that the forgoing represent non-limiting exemplary versions of the patient transport system 100.

Referring to FIG. 11A, as noted above, in some versions, at least one of the first and second powered devices PD1, PD2 may be further defined as an accessory device 248 configured to removably couple (e.g., electrically and/or mechanically) to the patient transport apparatus 102. Here, the patient transport apparatus 102 includes an apparatus interfaces 250A with a transmit element 252 arranged to cooperate with a receive element 254 of the device interface 250D of the corresponding accessory device 248 to facilitate power transfer between the patient transport apparatus 102 and the accessory device 248. It will be appreciated that the accessory device 248 may be configured to removably couple to the patient transport apparatus 102 in any manner known in the art, such as by a wired connection, wireless connection, fasteners, magnets, snaps, and the like. The apparatus controller 156A is configured to control the transfer of power via the transmit coil 252 and supplies the power to the device energy storage unit 168D for recharging or charging the device energy storage unit 168D, as described in greater detail below.

With continued reference to FIG. 11A, in some versions, at least one of the first and second powered devices PD1, PD2 may be further defined as the litter 112 adapted for releasable attachment to the intermediate frame 118 of the base 110 of the patient transport apparatus 102. The litter 112 includes a plurality of articulable assemblies, some of which may cooperate to define the patient support surface 114. Articulable assembles may include, but are not limited to, the fowler assembly 128, the front assembly 134, the rear assembly 140, and the ski assembly 144. Here, the base 110 of the patient transport apparatus 102 includes an apparatus interface 250A with a transmit element 252 arranged to cooperate with a receive element 254 of a litter interface 250L of the litter 112 to facilitate power transfer between the base 110 and the litter 112. Here, the transmit element 252 is operatively attached to the intermediate frame 118 and is arranged for alignment with the receive element 254 of the litter 112. In some configurations, the transmit element 252 is further defined as a transmit coil 252 and the receive element 254 is further defined as a receive coil 254. The transmit coil 252 and the receive coil 254 are adapted to cooperate such that power may be supplied from the base 110 of the patient transport apparatus 102 to the litter 112. In other words, the receive coil 254 of the litter 112 receives power from the transmit coil 252 of the apparatus interface 250A when the transmit coil 252 and the receive coil 254 are positioned within inductive proximity to each other. The apparatus controller 156A is configured to control the transfer of power via the transmit coil 252 and supplies the power to the litter energy storage unit 168L for recharging or charging the litter energy storage unit 168L, as described in greater detail below.

Referring to FIG. 11B, as noted above, the illustrated version is depicted with the patient transport apparatus 102 configured to transfer power to first, second, and third powered devices PD1, PD2, PD3 each realized as a different accessory device 248 that is configured to removably couple (e.g., electrically and/or mechanically) to the patient transport apparatus 102. Here, the patient transport apparatus 102 includes three apparatus interfaces 250A with respective transmit elements 252 arranged to cooperate with corresponding receive elements 254 of each of the device interfaces 250D of the first, second, and third powered devices PD1, PD2, PD3 to facilitate power transfer between the patient transport apparatus 102 and the accessory devices 248. The apparatus controller 156A is configured to control the transfer of power via the transmit coils 252, and supplies the power to the device energy storage units 168D of the respective first, second, and third powered devices PD1, PD2, PD3 for recharging or charging the device energy storage units 168D, as described in greater detail below.

It will be appreciated that the powered devices PD (e.g., the first, second, and third powered devices PD1, PD2, PD3 depicted in FIG. 11B) each include similar components (e.g., an interface 250, an energy storage unit 168, a controller 156, and the like). More specifically, in some configurations, the first powered device PD1 includes a first module MA to perform a powered function, a first device energy storage unit 168D1, and a first device user interface 158D1 arranged for user engagement to selectively operate the first module MA with power from the first device energy storage unit 168D1. The first powered device PD1 further includes a first device interface 250D1 in communication with a first device controller 156D1. The first device interface 250D1 is adapted to cooperate with one of the apparatus interfaces 250A to facilitate power transfer from the apparatus energy storage unit 168A to the first device energy storage unit 168D1. The first device controller 156D1 is in electrical communication with the first module MA, the first device energy storage unit 168D1, and the first device user interface 158D1.

In some configurations, the second powered device PD2 includes a second module MB to perform a powered function, a second device energy storage unit 168D2, and a second device user interface 158D2 arranged for user engagement to selectively operate the second module MB with power from the second device energy storage unit 168D2. The second powered device PD2 further includes a second device interface 250D2 in communication with a second device controller 156D2. The second device interface 250D2 is adapted to cooperate with one of the apparatus interfaces 250A to facilitate power transfer from the apparatus energy storage unit 168A to the second device energy storage unit 168D2. The second device controller 156D2 is in electrical communication with the second module MB, the second device energy storage unit 168D2, and the second device user interface 158D2.

In some configurations, the third powered device PD3 includes a third module MC to perform a powered function, a third device energy storage unit 168D3, and a third device user interface 158D3 arranged for user engagement to selectively operate the third module MC with power from the third device energy storage unit 168D3. The third powered device PD3 further includes a third device interface 250D3 in communication with a third device controller 156D3. The third device interface 250D3 is adapted to cooperate with one of the apparatus interfaces 250A to facilitate power transfer from the apparatus energy storage unit 168A to the third device energy storage unit 168D3. The third device controller 156D3 is in electrical communication with the third module MC, the third device energy storage unit 168D3, and the third device user interface 158D3.

As mentioned above, certain powered devices PD (e.g., the litter lift device 162 and/or the fowler section adjustment device 166 of the litter 112) may be operated by the apparatus controller 156A in response to engagement with the apparatus user interface 158A (e.g., the base user interface 158B and/or the litter user interface 158L) and/or based on signals received from the sensing system 160. In addition to controlling operation of the one or more powered devices PD, in some versions, the apparatus controller 156A also determines a current state SC (e.g., stored in memory of one or more controllers 156; not shown in detail) of the apparatus energy storage unit 168A (e.g., the base energy storage unit 168B and/or the litter energy storage unit 168L) based on input signals that the apparatus controller 156A receives from the apparatus user interface 158A and/or based on state signals that the apparatus controller 156A receives from the sensing system 160. In some configurations, the apparatus controller 156A may be configured to dynamically determine the current state SC of the apparatus energy storage unit 168A based historical information (e.g., stored in memory; not shown) and/or real-time information. The current state SC of the apparatus energy storage unit 168A may be related to an output level, a load condition, an energization status, or any other state of the apparatus energy storage unit 168A. As mentioned above, the sensing system 160 includes the state detection device 236 which, in some configurations, may be configured to couple to (or otherwise form a part of) the patient transport apparatus 102, including the base 110 and/or the litter 112. The apparatus controller 156A is configured to monitor the state of the patient transport apparatus 102, including any components directly, or indirectly. To this end, the state detection device 236 may generate state signals corresponding to the current state SC (or some other state) of the apparatus energy storage unit 168A, and send state signals to the apparatus controller 156A.

As shown in FIGS. 10-11B, in some versions, the controllers 156 of certain components of the patient support system 100 may include, employ, or otherwise communicate with one or more of a patient condition module 268, a power module 270, a priority module 272, an identification module 274, an authorization module 276, and/or a feedback module 278, each of which are described in greater detail below. Other modules are contemplated. In some versions, the device controller 156D and/or the apparatus controller 156A may include one or more power modules 270, priority modules 272, identification modules 274, authorization modules 276, feedback modules 278, and the like. Any of the modules may electrically couple to one or more modules in order to establish an interconnection/adaptation of other modules, and/or perform suitable functions not provided by the other modules. Although components of the patient support system 100 are primarily described herein as grouped in these modules, in some versions, components may be organized and grouped in other ways (e.g., combined, rearranged, and the like). It is contemplated that each powered device PD may include any or all of the modules introduced above and described in greater detail below unless otherwise indicated.

In some configurations, the patient condition module 268 of the patient support system 100 is configured to generate a patient condition signal SP (not shown in detail) indicating changes in patient condition. Here, the apparatus controller 156A is disposed in communication with the patient condition module 268 and configured to make determinations related to at least one of the powered devices PD based on the patient condition. In some variations, the sensing system 160 may be used to determine a current patient condition such that the patient condition module 268 generates the patient condition signal SP based on the current patient condition. Various patient conditions may be determined and may be used to control operation of the powered devices PD. Such patient conditions may include current positions of the patient (e.g., the patient is slouched, the patient is off center, the patient is lying supine, the patient is getting ready to exit, the patient is sitting up, etc.). Patient conditions can also comprise physiological conditions (e.g., a patient's heart rate, respiration, temperature, blood pressure, the patient is sleeping, the patient is coughing, skin conditions of the patient, etc.). Patient conditions can also comprise standard patient characteristics (e.g., weight, width, height, pathology, race, etc.). Patient conditions can also comprise patient history (e.g., activity level, movement history, etc.). Patient conditions can be determined by the apparatus controller 156A using the sensing system 160 (e.g., via the use of physiological sensors, imaging sensors, temperature sensors, weight sensors, position sensors, heart monitor sensors, and the like) and/or the patient condition module 268, and/or by input from the caregiver, patient, or other person, or retrieved from an electronic medical record (EMR). Other configurations are contemplated. Thus, in some configurations, the patient condition module 268 may form a part of the sensing system 160, which may be realized as a part of the patient transport apparatus 102 and/or may be realized as another portion of the patient support system 100.

As noted above, the powered devices PD each generally include a controller 156 (e.g., each accessory device 248 may include a respective device controller 156D). The controllers 156 of powered devices PD may include, define, or otherwise utilize power modules 270 to perform power management of, in particular, its respective energy storage unit 168 to facilitate operation of the powered device PD. Put differently, charging of the energy storage unit 168 of the powered device PD may be achieved via the power module 270. The power module 270 may manage batteries, monitor and/or manage direct power connections, and/or provide power to other components, systems, and the like. The power module 270 may also response to queries, such as to determine characteristics, states, conditions, and the like of the powered device PD. The power module 270 may manage power from a variety of sources, and may provide power to whichever components, modules, and the like to facilitate operation. To this end, the power module 270 is configured to determine a charging level LC (e.g., stored in memory of one or more controllers 156; not shown in detail) for the energy storage unit 168 (e.g., the device energy storage unit 168D) based on the current state SC of the apparatus energy storage unit 168A (or some other energy storage unit 168), and to draw power from the apparatus energy storage unit 168A (or some other energy storage unit 168) via the apparatus interface 250A (or some other interface 250) and across its interface 250 (e.g., the device interface 250D) to charge its energy storage unit 168 (e.g., the device energy storage unit 168D) at the charging level LC. Further, the power module 270 is configured to determine a maximum output level MO (e.g., stored in memory of one or more controllers 156; not shown in detail) of the apparatus energy storage unit 168A (or some other energy storage unit 168), calculate an available output level AO (e.g., stored in memory of one or more controllers 156; not shown in detail) based the difference between the maximum output level MO and the current output level CO, and adjust the power drawn from the apparatus energy storage unit 168A from the apparatus interface 250A based on the available output level AO of the apparatus energy storage unit 168A. Additionally, as mentioned above, the apparatus controller 156A may be configured to monitor the current state SC of the apparatus energy storage unit 168A. Based on the monitoring, the apparatus controller 156A may be configured to transmit the current state SC to the power module 270 of the device controller 156D. In this way, the power module 270 of each powered device PD can be updated on, informed of, or otherwise receive the current state SC of the apparatus energy storage unit 168A (or some other energy storage unit 168) such that the energy storage units 168 of each powered device PD may efficiently and properly charged. As is described in greater detail below charging of different energy storage units 168 may be carried out in various ways to, among other things, ensure proper utilization of powered devices PD under different operating conditions.

In configurations with more than one powered device PD, such as the first powered device PD1 and the second powered device PD2, each powered device PD1, PD2 includes or otherwise employs a respective power module 270. For example, the first powered device PD1 includes a first power module 270A and the second powered device PD2 includes a second power module 270B. The first power module 270A is configured to determine a first charging level LC1 for the first powered device PD1 based on a current state SC of the apparatus energy storage unit 168A, and to draw power from the apparatus energy storage unit 168A via the apparatus interface 250A and across the first device interface 250D1 to charge the first device energy storage unit 168D1 at the first charging level LC1. The second power module 270B is configured to determine a second charging level LC2 for the second powered device PD2 based on the current state SC of the apparatus energy storage unit 168A, and to draw power from the apparatus energy storage unit 168A via the apparatus interface 250A and across the second device interface 250D2 to charge the second device energy storage unit 168D2 at the second charging level LC2. Here, by determining the first and second charging levels CL1, CL2 based on the current state SC of the apparatus energy storage unit 168A, the first and second powered devices PD1, PD2 are able to draw power from the apparatus energy storage unit 168A without compromising each other or the apparatus energy storage unit 168A. For instance, the first and second powered devices PD1, PD2 can draw power up to the maximum output level MO of the apparatus energy storage unit 168A. More specifically, the first and second power modules 270A, 270B are further configured to determine the maximum output level MO of the apparatus energy storage unit 168A, calculate an available output level AO based the difference between the maximum output level MO and a current output level CO (e.g., stored in memory of one or more controllers 156; not shown in detail) (e.g., based on the current state SC), adjust the power drawn from the apparatus energy storage unit 168A from the apparatus interface 250A based on the available output level AO of the apparatus energy storage unit 168A. The adjustment of power drawn from the apparatus energy storage unit 168A may be continuous. In this way, the patient transport apparatus 102 can ensure sufficient and/or efficient power distribution to one or more powered devices PD without compromising the apparatus energy storage unit 168A.

Each powered device PD, including the first and second powered devices PD1, PD2, may include identity data ID (e.g., stored on memory of its controller 156; not shown in detail) for identifying specific powered devices PD. The identity data ID may include identity data such as one or more of a passcode, a key, a serial number, a media access control MAC address, a common entity, a customer name or identification, and/or a user name or identification, a priority level PL, and/or an authorization level AL. Each identity data ID may be unique to the particular powered device PD. Other identity data ID are contemplated. In some versions, the apparatus controller 156A may be configured to control operation and/or function of, and/or the connection with, one or more powered devices PD which form a part of or otherwise cooperate with the patient transport apparatus 102 (or another part of the patient support system 100) based at least partially on the identity data ID associated with each powered device PD.

In some versions, the apparatus controller 156A may employ the priority module 272 for prioritizing power transfer to one or more powered devices PD. The priority module 272 is configured to determine a priority level PL (e.g., stored in memory of one or more controllers 156; not shown in detail) associated with powered devices PD. Here, the priority level PL may be utilized to dictate whether the powered device PD receives power (and/or how much power) from the apparatus energy storage unit 168A (or another energy storage unit 168 of the patient support system 100). The priority module 272 is configured to facilitate transferring power from the apparatus energy storage unit 168A (or another energy storage unit 168) via the apparatus interface 250A and across the device interface 250D to charge the device energy storage unit based on the priority level PL. In some versions, the priority module 272 is configured to determine the priority level PL of every powered device PD. For instance, in configurations with more than one powered device PD, the priority module 272 may be configured to determine respective priority levels PL associated with the first powered device PD1 and the second powered device PD2, and to transfer power from the apparatus energy storage unit 168A via the apparatus interface 250A and across the first and third device interfaces 250D1, 250D2 to respectively charge the first and second device energy storage units 168D1, 168D2 based on the respective priority levels PL of the first and second powered devices PD1, PD2.

In some versions, power transmission between energy storage units 168 is based at least partially on priority level PL. For a particular powered device PD, the apparatus controller 156A may be configured to allow the powered device PD to receive power from the patient transport apparatus 102 (or another portion of the patient support system 100) in response to the priority level PL associated with that particular powered device PD being at a first priority level PL1 (e.g., stored in memory of one or more controllers 156; not shown in detail), to delay power transmission to the powered device PD in response to the priority level PL being at a second priority level PL2 (e.g., stored in memory of one or more controllers 156; not shown in detail), and to restrict power transmission to the powered device PD in response to the priority level PL being at a third priority level PL3 (e.g., stored in memory of one or more controllers 156; not shown in detail).

The priority module 272 may include a priority order PO (e.g., stored in memory of one or more controllers 156; not shown in detail) used to facilitate charging each of the powered devices PD based on their respective priority levels PL. In some configurations, the apparatus controller 156A may be configured to utilize the priority module 272 to compare the respective priority levels PL associated with each powered device PD to a threshold PLT (e.g., stored in memory of one or more controllers 156; not shown in detail), and to identify one or more powered devices PD having an indication of a priority level PL at or below the threshold PLT. The priority module 272 may determine the priority order PO of charging of each powered device PD based on the indication of its priority level PL relative to the threshold PLT. For example, the priority module 272 may be in communication with the power module 270 and the charging level LC of the powered device PD may include a percentage of battery charge of the device energy storage unit 168D, and the threshold PLT may correspond to a value of the percentage of charge. To illustrate, the threshold may correspond to a 90% battery charge level. While this is an illustrative example, in other configurations, the threshold PLT may be less than 90% or greater than 90%. In another illustrative example with two powered devices PD, the value of the percentage of battery charge of the first powered device PD1 may be 89% and the value of the percentage of battery charge of the second powered device PD2 may be 20%. Accordingly, because the energy storage units 168 of the first and second powered devices PD1, PD2 are both at or below the threshold PLT of 90%, they may both be charged.

In some configurations, the priority module 272 (or another portion of the apparatus controller 156A) may employ a charging selector 280 to identify the priority order PO of charging each of the powered devices PD. Based on the priority order PO, the charging selector 280 may select a highest priority powered device PD, determine at least one of an amount of remaining power in the apparatus energy storage unit 168A (or some other energy storage unit 168), the available output level AO of the apparatus energy storage unit 168A (or some other energy storage unit 168), and the current state SC of the apparatus energy storage unit 168A (or some other energy storage unit 168), and assign a percentage of the remaining power to the highest priority powered device PD. Then, the charging selector 280 may select a next highest priority powered device PD, determine at least one of an amount of remaining power in the apparatus energy storage unit 168A (or some other energy storage unit 168), the available output level AO of the apparatus energy storage unit 168A (or some other energy storage unit 168), and the current state SC of the apparatus energy storage unit 168A (or some other energy storage unit 168), and assign another percentage of the remaining power to the next highest priority powered device PD, which may be the same as the percentage of the remaining power assigned to the highest priority powered device PD. It is contemplated that more than one powered device PD may be selected as the “highest” priority powered device PD, in which case the charging selector 280 may assign the percentage of the remaining power based on other factors or predetermined criterion. Alternatively, the other percentage of the remaining power may be different than the percentage of the remaining power assigned to the highest priority powered device PD. Here, the charging selector 280 may select any powered device PD and assign any power remaining to the powered device PD. Alternatively, or additionally, depending on the current state SC of the apparatus energy storage unit 168A, the apparatus controller 156A may allow both powered devices PD to receive power transmission at the same time.

In another example, the charging level LC of the powered device PD may include a percentage of battery needed to reach maximum charge. To illustrate by way of example, in FIG. 11B, the value of the percentage of battery charge of the first powered device PD1 may be 89%, the second powered device PD2 may be 99%, and a third powered device PD3 may be 100%. In this case, the first charging level LC1 would be 11%, the second charging level LC2 would be 1%, and the third charging level LC3 would be 0%. Accordingly, the apparatus controller 156A may utilize the charging selector 280 to determine that the first powered device PD1 is at the first priority level PL1 and the second powered device PD2 is at the second priority level PL2. Alternatively, depending on the current state SC of the apparatus energy storage unit 168A, the apparatus controller 156A may allow both the first and second powered devices PD1, PD2 to receive power transmission at the same time.

In other configurations, the priority order PO may be based on a charging hierarchy such that powered devices PD with a higher priority level PL are provided with power before powered devices PD with a lower priority level PL. In some configurations, the first priority level PL1 is the highest priority level PL, and the third priority level PL3 is the lowest priority level PL, with the second priority level PL2 between the highest and the lowest priority levels PL1, PL3. In this illustrative example, the apparatus controller 156A may be configured to delay power transmission to the certain powered devices PD for a predetermined time. This may be utilized where the charging level LC of a powered device PD includes or is based on the percentage of battery needed to reach maximum charge. Here, a powered device PD having the highest charging level LC (e.g., not charged) may be determined as having the highest priority (or the first priority level PL1), a powered device PD having the lowest charging level LC (e.g., partially charged) may be determined as having the second priority level PL2, and a powered device PD having no charging level LC (e.g., fully charged) may be determined as having the third priority level PL3. It will be appreciated that the forgoing represent illustrative examples, and the priority levels PL could be defined in various ways.

In some configurations, the priority module 272 is in communication with the patient condition module 268 such that the apparatus controller 156A is disposed in communication with the patient condition module 268 and is configured to determine the priority level PL at least partially based on the patient condition (e.g., via the patient condition signal SP). Further, the apparatus controller 156A may be configured to modify the priority level PL associated with certain powered devices PD based on changes in the patient condition. For example, if the patient condition signal SP is indicative of improving patient condition, the apparatus controller 156A may be configured to modify the priority level PL associated with the powered device PD from the first priority level PL1 to the third or third priority levels PL2, PL3 based on the patient condition signal SP. If the patient condition signal SP is indicative of worsening patient condition, the apparatus controller 156A is to modify the priority level PL associated with the powered device PD from the second priority level PL2 or third priority level PL3 to the first priority level PL1 based on the patient condition signal SP. If the patient condition signal SP is indicative of no patient condition or no changes in patient condition, the apparatus controller 156A may modify the priority level PL associated with the powered device PD from the first priority level PL1 or the second priority level PL2 to the third priority level PL3 based on the patient condition signal SP. Other configurations are contemplated.

To illustrate the forgoing example, the first powered device PD1 may be the litter 112 with the first priority level PL1 and the second powered device PD2 may be further defined as the accessory device 248 realized as a defibrillator, with the priority level PL being the third priority level PL3. Initially, the apparatus controller 156A may allowing the litter 112 to receive power and may restrict power to the accessory device 248 (the defibrillator). However, while adjusting the patient support surface 114 for the patient, it is possible that the patient condition would worsens (e.g., based on heart monitor data, or similar data, communicated via the patient condition signal SP), such as where the patient suddenly goes into cardiac arrest. The patient condition module 268 generates the patient condition signal SP indicative of the worsening patient condition and, in response, the apparatus controller 156A modifies the priority level PL associated with the accessory device 248 (the defibrillator). Here, the apparatus controller 156A could modify the priority level PL from the third priority level PL3 to the first priority level PL1, allowing the accessory device 248 (the defibrillator) to receive power from the patient transport apparatus 102 thereby providing the accessory device 248 (the defibrillator) ample power the device and/or continually charge the device energy storage unit 168D. Here too, it will be appreciated that the forgoing is an illustrative example, and other configurations are contemplated.

The apparatus controller 156A may be configured distribute power transferred from the apparatus energy storage unit 168A to the powered device PD based on at least one of a current state SC of the apparatus energy storage unit 168A and the priority level PL associated with the powered device PD, and to re-distribute the power transferred from the apparatus energy storage unit 168A to the powered device PD based at least partially on changes in the priority level PL associated with the powered device PD and the current state SC of the apparatus energy storage unit 168A. With continued reference to the illustrative example provided above, depending on the current state SC of the apparatus energy storage unit 168A, the apparatus controller 156A may also modify the priority level PL associated with the litter 112. For example, if the apparatus energy storage unit 168A does not have enough available output to provide power to both the litter 112 and the accessory device 248 (the defibrillator) in the event the patient enters sudden cardiac arrest, the apparatus controller 156A may prioritize providing power to the accessory device 248 (the defibrillator) and modifies the priority level PL associated with the litter 112 from the first priority level PL1 to the third priority level PL3. Here, the apparatus controller 156A may first check that the fowler assembly 128 is lowered, or may otherwise modify the power distribution so as to ensure that the fowler assembly 128 has sufficient power to be lowered. Nevertheless, the apparatus controller 156A may apply a different power transmission strategy to the accessory device 248 (the defibrillator) and to the litter 112 in response to the priority level PL changing based on certain changes in patient condition. In another example, if the apparatus energy storage unit 168A does have enough available output to provide power to both the litter 112 and the accessory device 248 (the defibrillator), the apparatus controller 156A may modify the priority level PL associated with the accessory device 248 (the defibrillator) from the third priority level PL3 to the first priority level PL1, and re-distribute the power transferred such that a greater percentage of power may be provided to the accessory device 248 (the defibrillator) than the percentage of power provided to the litter 112. Here too, it will be appreciated that the forgoing is an exemplary scenario of how the priority module 272, in combination with the patient condition module 268 and the power module 270, may be utilized. However, other configurations are contemplated.

In some versions, the apparatus controller 156A may employ the authorization module 276 to determine authorization of access associated with each powered device PD. As is described in greater detail below, the authorization module 276 can allow, limit, or otherwise prevent powered devices PD from accessing (e.g., receiving power from) or connecting to the patient transport apparatus 102. More specifically, the authorization module 276 can allow, limit, or otherwise prevent the powered devices PD from receiving power from the apparatus energy storage unit 168A (or another energy storage unit 168 of the patient support system 100). The authorization module 276 may be configured to receive authorization information IA (e.g., stored in memory of one or more controllers 156; not shown in detail) from the powered device PD via the wireless communication module 260. The authorization information IA may be related to whether the powered device PD has permission to receive power from the patient transport apparatus 102 or another portion of the patient support system 100. Once received, the authorization module 276 may compare the authorization information AI relative to a predetermined authorization criterion PAC (e.g., stored in memory of one or more controllers 156; not shown in detail), and modify the priority level PL based on the comparison of the authorization information AI relative to the predetermined authorization criterion PAC.

In some configurations, the identity data ID may include authorization information IA (e.g., stored in memory of one or more controllers 156; not shown in detail) defining an authorization level AL (e.g., stored in memory of one or more controllers 156; not shown in detail) used to determine whether the powered device PD has full access to the patient transport apparatus 102 (e.g., to receive power from one or more energy storage units 168). For example, the apparatus controller 156A (or another controller 156) may allow access (e.g., permit power transmission), partially limit access (e.g., prevent or only allow minimal power transmission), or completely limit/restrict access (e.g., prevent power transmission) based on the authorization level AL. Other configurations are contemplated.

In some versions, the apparatus controller 156A employs the identification module 274 to facilitate identifying powered devices PD, and the device controllers 156D employ a feedback module 278 in communication with the identification module 274. The device controller 156D of the powered device PD is configured to transmit identity data ID associated with the powered device PD to the apparatus controller 156A. Based on the identity data ID, the identification module 274 is further configured to determine an identification profile IP associated with the powered device PD. Transmission of the identity data ID may be accomplished via any type of wireless communication module 260. For example, in some versions the device controller 156D may be configured to wirelessly transmit the identity data of the powered device PD to the apparatus controller 156A according to the BLE protocol. Other configurations are contemplated, such as radio frequency identification RFID, near field communication NFC, Qi standard communication, and the like. Further, in some versions, the feedback module 278 may be configured to provide feedback FB (e.g., stored in memory of one or more controllers 156; not shown in detail) upon detection of changes related to the powered device PD and to wirelessly transmit the identity data ID to the apparatus controller 156A via the respective wireless communication modules 260 based on the feedback FB.

In some versions, the apparatus controller 156A (or some other controller 156) may be further configured to allow, limit, or otherwise prevent powered devices PD from accessing or connecting to the patient transport apparatus 102 (and/or various energy storage units 168) based on communications with the identification module 274, or the combination of the identification module 274 and the feedback module 278. More specifically, the apparatus controller 156A may be configured to at least partially allow, limit, and/or restrict the transfer of power from the patient transport apparatus 102 to certain powered devices PD based on the identification profile IP and/or the identity data ID of the powered device PD.

The identification module 274 may be configured to receive the identity data ID from the powered device PD, to identify the powered device PD based on the identity data ID, and to transfer power from the apparatus energy storage unit 168A (or some other energy storage unit 168) via the apparatus interface 250A (or some other interface 250) and across the device interface 250D to charge the device energy storage unit 168D based on the identity data ID. In some configurations, the device controller 156D is configured to wirelessly transmit at least a portion of the identification profile IP of the powered device PD from the device controller 156D to the apparatus controller 156A.

In some versions, the feedback module 278 is configured to initiate a pairing process between the powered device PD and the patient transport apparatus 102 based a pairing signal SP. The communication between the powered device PD and the patient transport apparatus 102 can be based at least on the pairing signal SP transmitted from the feedback module 278 to the device controller 156D. The pairing signal SP and the identity data ID can be transmitted via the wireless communication module 260 of the powered device PD. In some versions, the device controller 156D may be configured to transmit the pairing signal SP to the apparatus controller 156A, and the apparatus controller 156A may be configured to receive the pairing signal SP (or vice-versa). Once received, the apparatus controller 156A determines whether to connect the powered device PD to the patient transport apparatus 102 based on the pairing signal SP. For example, if the powered device PD is not recognized or authorized based on the pairing signal SP, power may not be transferred to the powered device PD from any of the energy storage units 168

In some versions, the identity data ID can be transmitted from the powered device PD to the patient transport apparatus 102 in response to the transmission of the pairing signal SP from the feedback module 278. Here, the identity data ID may be transmitted automatically in response to receiving the pairing signal SP. In other configurations, transmission of the identity data ID may not occur automatically. In some versions, utilizing both the feedback module 278 and the identification module 274 can help prevent cross-pairing of powered devices PD and/or components of different patient transport apparatuses 102 (e.g., to ensure that the correct litter 112 and base 110 are paired to each other when two patient transport apparatuses 102 of similar configurations are stored or transported near each other).

In some configurations, the pairing process between the powered device PD and the patient transport apparatus 102 may be based on proximity, which may be referred to as a proximity pairing process. For example, the feedback module 278 may transmit the pairing signal SP to the powered device PD when the powered device PD is brought within a predetermined distance from the patient transport apparatus 102. In another example, the feedback module 278 may be configured to detect positional changes of the powered device PD relative to the patient transport apparatus 102 and initiate the proximity pairing process in response to determining the wireless communication module 260D of the powered device PD is within a predetermined proximity of the wireless communication module 260A of the patient transport apparatus 102, at which point the feedback module 278 can transmit the pairing signal SP, including the identity data ID.

It is contemplated that other changes related to the powered device PD may be utilized to facilitate initiating pairing processes, including, but not limited to, changes in orientation, direction of movement, as well as shape, size, and the like. In addition, the feedback module 278 may be configured to detect positional changes of one or more powered devices PD relative to the patient transport apparatus 102 and initiate the proximity pairing process for the powered device PD closest to the patient transport apparatus 102. It is contemplated that the predetermined proximity may include, but is not limited to, to a predetermined distance. In some versions, the feedback module 278 may detect that the first powered device PD1 is 1 foot away from the patient transport apparatus 102 and the second powered device PD2 is 1.5 feet away from the patient transport apparatus 102. Here, the first powered device PD1 is closer to the patient transport apparatus 102 than the second powered device PD2. Thus, the feedback module 278 could initiate the proximity pairing process between the first powered device PD1 and the patient transport apparatus 102. To further illustrate, the feedback module 278 may detect positional changes of the first powered device PD1 and the second powered device PD2. Here, for example, the first powered device PD1 could be 0.5 feet away from the patient transport apparatus 102 and the second powered device PD2 may still be 1.5 feet away from the patient transport apparatus 102. In such circumstances, the feedback module 278 may initiate the proximity pairing process between the second powered device PD2 and the patient transport apparatus 102.

Alternatively, or additionally, the feedback module 278 may be configured to delay the pairing process. For example, continuing with the illustrative example provided above, in the event the feedback module 278 detects the second powered device PD2 as being 1.5 feet away from the patient transport apparatus 102, the feedback module 278 may be configured to delay the pairing process. In such example, the feedback module 278 may delay for a predetermined time to assess whether any other powered device PD is within the predetermined proximity of the wireless communication module 260 of the patient transport apparatus 102. This prevents any unintentional pairing or cross pairing between the first and second powered devices PD1, PD2 and the patient transport apparatus 102.

In some configurations, the pairing process between the powered device PD and the patient transport apparatus 102 may be based at least partially on at least one of a magnetic, electric, and/or electromagnetic field. For example, the feedback module 278 may be configured to detect changes in a field B (not shown in detail) generated between respective wireless subsystems 258, and may initiate transmission of the identity data ID to the apparatus controller 156A based on predetermined changes detected in the field B. To illustrate, in some versions as mentioned above, the transmit element 252 of the patient transport apparatus 102 may be adapted to cooperate with the receive element 254 of the powered device PD to facilitate power transfer from the apparatus energy storage unit 168A to the device energy storage unit 168D. In some configurations, the transmit element 252 is further defined as the transmit coil 252 which generates the field B, and the receive element 254 is further defined as the receive coil 254. The powered device PD receives power from the patient transport apparatus 102 when the transmit coil 252 and the receive coil 254 are positioned within inductive proximity to each other. In some configurations, the transmit coil 252 generates the field B and interaction of the receive coil 254 with the field B at least partially changes the field B based on the proximity between the transmit coil 252 and the receive coil 254. More specifically, the transfer of power from the patient transport apparatus 102 to the powered device PD may be carried out by the apparatus controller 156A that runs a changing electrical current through the transmit coil 252. This creates a changing magnetic field around the transmit coil 252, which when the receive coil 254 is closely positioned nearby, induces a changing electric field within the receive coil 254, thereby creating electrical current within the receive coil 254 of the powered device PD. The device energy storage unit 168D harnesses the energy inductively generated for providing power to components of the powered device PD.

Those having ordinary skill in the art will appreciate that the operation of the authorization module 276 and/or the identification module 274 may be based on utilization of an access system 282 to identify and differentiate between powered devices PD. The patient support system 100 may further include the access system 282 configured to identify and respond to certain changes related to the patient transport apparatus 102 and powered devices PD. By way of non-limiting example, the access system 282 may “respond” to changes by updating identity data ID and/or changing a user's ability to access a powered function of a powered device PD. In some configurations, the operation of the authorization module 276 and/or the identification module 274 described herein can be based on conventional identification and differentiation methods or systems related to the identity data ID. The access system 282 may adaptively recognize, monitor, and/or update the identification profiles IP associated with each powered device PD based on the feedback module 278. It will be appreciated that any powered device PD can serve as part of, or otherwise cooperate with, the access system 282.

As mentioned above, any module 260, 268, 270, 272, 274, 276, 278 may be interconnected with some or all of the other modules 260, 268, 270, 272, 274, 276, 278 and may provide aid in interconnection/adaptation of other modules 260, 268, 270, 272, 274, 276, 278, and/or perform suitable functions not provided by the other modules 260, 268, 270, 272, 274, 276, 278.

It is contemplated that the device controller 156D of each powered device PD includes any number of power modules 270 or other modules, denoted as a first respective module, second respective module, and so on. However, note that the first module MA associated with the first powered device PD1 and the second module MB associated with the second powered device PD2 are configured to be a part of the first and second powered devices PD1, PD2 and to perform different powered functions. Unless otherwise stated, the first module MA and the second module MB are different from the first and second power modules 270A, 270B. It is further contemplated that the apparatus controller 156A (e.g., the base controller 156B and/or the litter controller 156L), or some other controller 156 of the patient support system 100, may include any number of priority modules 272, authorization modules 276, identification modules 274, feedback modules 278, and other modules, denoted as a first respective module, second respective module, and so on. For example, the base controller 156B and the litter controller 156L may each include a respective priority module 272, authorization module 276, identification module 274, and feedback module 278, and the like.

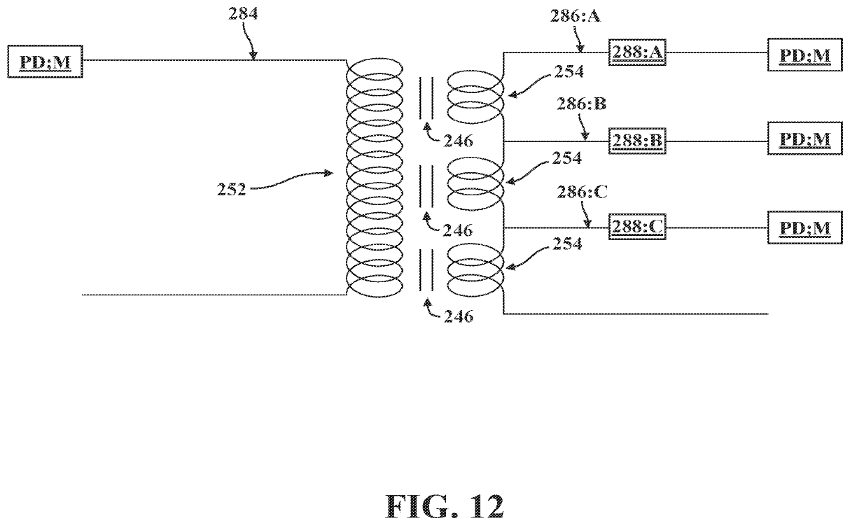

Referring now to FIG. 12, an illustrative schematic depicting one version of power connections 246 of the patient support system 100 is shown. Here, one powered device PD (e.g., the ambulance 106, the power load device 108, the patient transport apparatus 102, and the like) is shown having a primary rail 284 (e.g., a rectified direct current rail) with a transmit element 252 (e.g., a transmit coil) arranged to provide power to different secondary rails 286 (286A, 286B, 286C) (e.g., rectified direct current rails) via correspondingly different receive elements 254 (e.g., receive coils) to provide power to different powered devices PD and/or modules M of the patient support system 100 (e.g., accessory devices 248, the litter 112, and the like). Here too, each of the secondary rails 286A, 286B, 286C is provided with a respective gate 288 (288A, 288B, 288C), which may be utilized by one or more of the modules of the controllers 156 described above to, among other things, facilitate interrupting or limiting power delivery to the energy storage units 168 of the powered devices PD, to prevent unauthorized access to the energy storage unit 168 providing power to the primary rail 284, and the like. In some versions, each of the secondary rails 286A, 286B, 286C may be configured to provide different power requirements to the respective powered devices PD and/or modules M (e.g., different voltages, currents, and the like). Here, for example, if the primary rail 284 were configured to operate at 36 VDC, one of the secondary rails 286A may operate at a high voltage (e.g., 24 VDC), another of the secondary rails 286B may operate at a low voltage (e.g., 5 VDC), and another of the secondary rails 286C may operate at a mid voltage (e.g., 12 VDC). Other configurations are contemplated, including those where each secondary rail 286 operates at substantially the same voltage. One or more of the controllers 156 and/or modules of the various powered devices PD of the patient support system 100 may be configured to monitor voltage, current, inductance, and the like across one or more of the rails 284, 286 to, among other things, determine available power from different energy storage units 168, facilitate changing priority levels PL, detect the presence and/or absence of other powered devices PD drawing power primary rail 284, and the like. Other configurations are contemplated.

It will be further appreciated that the terms “include,” “includes,” and “including” have the same meaning as the terms “comprise,” “comprises,” and “comprising.” Moreover, it will be appreciated that terms such as “first,” “third,” “third,” and the like are used herein to differentiate certain structural features and components for the non-limiting, illustrative purposes of clarity and consistency.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient support system comprising:
a patient transport apparatus including:
   a base frame arranged for movement about floor surfaces,
   an intermediate frame to provide support to a patient,
   a powered adjustment device,
   an apparatus energy storage unit,
   an apparatus user interface arranged for user engagement to selectively operate the powered adjustment device with power from the energy storage unit,
   an apparatus controller in electrical communication with the powered adjustment device, the apparatus energy storage unit, and the apparatus user interface, and
   an apparatus interface in communication with the apparatus controller; and
a powered device including:
   a module to perform a powered function,
   a device energy storage unit,
   a device user interface arranged for user engagement to selectively operate the module with power from the device energy storage unit,
   a device interface in communication with the device controller, the device interface adapted to cooperate with the apparatus interface to facilitate power transfer from the apparatus energy storage unit to the device energy storage unit, and
   a device controller in electrical communication with the module, the device energy storage unit, and the device user interface, the device controller including a power module configured to determine a charging level for the device energy storage unit based on a current state of the apparatus energy storage unit, and to draw power from the apparatus energy storage unit via the apparatus interface and across the device interface to charge the device energy storage unit at the charging level.

II. The patient support system of clause I, wherein the apparatus interface includes a transmit element and the device interface includes a receive element to facilitate power transfer between the patient transport apparatus and the powered device.

III. The patient support system of clause II, wherein the transmit element is further defined as a transmit coil and the receive element is further defined as a receive coil, the transmit coil and the receive coil are adapted to cooperate to facilitate supplying power from the patient transport apparatus to the powered device.

IV. The patient support system of any of clauses I-III, wherein the current state of the apparatus energy storage unit includes a current output level; and
wherein the power module is further configured to:
   determine a maximum output level of the apparatus energy storage unit,
   calculate an available output level based the difference between the maximum output level and the current output level, and
   adjust the power drawn from the apparatus energy storage unit from the apparatus interface based on the available output level of the apparatus energy storage unit.

V. The patient support system of any of clauses I-IV, wherein the apparatus controller is disposed in electrical communication with the device controller; and
wherein the apparatus controller is further configured to monitor the current state of the apparatus energy storage unit, and to transmit the current state to the power module of the device controller.

VI. The patient support system of any of clauses I-V, wherein the powered device is further defined as an accessory device configured to removably couple to the patient transport apparatus.

VII. The patient support system of any of clauses I-VI, wherein the powered adjustment device is further defined as a base lift device configured to adjust a height of the intermediate frame relative to the base frame.

VIII. The patient support system of clause VI, wherein the apparatus interface includes a transmit element and the device interface includes a receive element to facilitate power transfer between the patient transport apparatus and the accessory device.

IX. The patient support system of any of clauses I-VIII, wherein the powered device is further defined as a litter adapted for releasable attachment to the intermediate frame of the patient transport apparatus, the litter including a plurality of articulable assemblies defining a patient support surface.

X. The patient support system of clause IX, wherein the apparatus interface includes a transmit element and the device interface of the litter includes a receive element to facilitate power transfer between the patient transport apparatus and the litter.

XI. The patient support system of clause X, wherein the transmit element is operatively attached to the intermediate frame and is arranged for alignment with the receive element; and
wherein the transmit element is further defined as a transmit coil and the receive element is further defined as a receive coil, the transmit coil and the receive coil are adapted to cooperate such that power may be supplied from the patient transport apparatus to the powered device.

XII. The patient support system of any of clauses I-XI, wherein the apparatus controller is disposed in electrical communication with the device controller; and
wherein the powered device further includes:
   a wireless subsystem in electrical communication with the device controller, and
   a wireless communication module operable to wirelessly transfer data and to provide, through the wireless communication module, wireless communication between the device controller and the apparatus controller.

XIII. The patient support apparatus of clause XII, wherein the wireless subsystem is further defined as a controller area network (CAN) subsystem.

XIV. The patient support apparatus of clause XIII, wherein the wireless communication module is configured to operate according to a Bluetooth Low Energy (BLE) protocol.

XV. A patient support system comprising:
a patient transport apparatus including:
   a base frame arranged for movement about floor surfaces,
   an intermediate frame to provide support to a patient,
   a powered adjustment device,
   an apparatus energy storage unit,
   an apparatus user interface arranged for user engagement to selectively operate the powered adjustment device with power from the energy storage unit,
   an apparatus controller in electrical communication with the powered adjustment device, the apparatus energy storage unit, and the apparatus user interface, and
   an apparatus interface in communication with the apparatus controller;
a first powered device including:
   a first module to perform a powered function,
   a first device energy storage unit,
   a first device user interface arranged for user engagement to selectively operate the first module with power from the first device energy storage unit,
   a first device interface in communication with the first device controller, the first device interface adapted to cooperate with the apparatus interface to facilitate power transfer from the apparatus energy storage unit to the first device energy storage unit, and
   a first device controller in electrical communication with the first module, the first device energy storage unit, and the first device user interface; and
a second powered device including:
   a second module to perform a powered function,
   a second device energy storage unit,
   a second device user interface arranged for user engagement to selectively operate the second module with power from the second device energy storage unit,
   a second device interface in communication with the second device controller, the second device interface adapted to cooperate with the apparatus interface to facilitate power transfer from the apparatus energy storage unit to the second device energy storage unit, and
   a second device controller in electrical communication with the second module, the second device energy storage unit, and the second device user interface,
wherein the first device controller includes a first power module configured to determine a first charging level for the first powered device based on a current state of the apparatus energy storage unit, and to draw power from the apparatus energy storage unit via the apparatus interface and across the first device interface to charge the first energy storage unit at the first charging level,
wherein the second device controller includes a second power module configured to determine a second charging level for the second powered device based on the current state of the apparatus energy storage unit, and to draw power from the apparatus energy storage unit via the apparatus interface and across the second device interface to charge the second energy storage unit at the second charging level.

XVI. The patient support system of clause XV, wherein the apparatus interface includes a transmit element, the first device interface includes a first receive element, and the second device interface includes a second receive element, wherein the transmit element and the first and second receive elements are configured to facilitate power transfer between the patient transport apparatus and the first and second powered devices, respectively.

XVII. The patient support system of clause XVI, wherein the transmit element and at least one of the first receive element and the second receive element are adapted to cooperate such that power may be supplied from the patient transport apparatus to the first and second powered devices.

XVIII. The patient support system of any of clauses XVI-XVII, wherein the apparatus interface includes a second transmit element, different from the first transmit element, to transfer power independent of the first transmit element.

XIX. The patient support system of any of clauses XV-XVIII, wherein the current state of the apparatus energy storage unit includes a current output level; and
wherein the first and second power modules are further configured to:
   determine a maximum output level of the apparatus energy storage unit,
   calculate an available output level based the difference between the maximum output level and the current output level,
   adjust the power drawn from the apparatus energy storage unit from the apparatus interface based on the available output level of the apparatus energy storage unit.

XX. The patient support system of clause XIX, wherein the apparatus controller is configured to distribute the power between the first and second powered devices based on the available output level of the apparatus energy storage unit.

XXI. The patient support system of any of clauses XV-XX, wherein the apparatus controller is disposed in electrical communication with the first and second device controllers; and
wherein the apparatus controller is further configured to monitor the current state of the apparatus energy storage unit, and to transmit the current state to the first and second power modules of the first and second device controllers.

XXII. A patient support system comprising:
a patient transport apparatus including:
   a base frame arranged for movement about floor surfaces,
   an intermediate frame to provide support to a patient,
   a powered adjustment device,
   an apparatus energy storage unit,
   an apparatus user interface arranged for user engagement to selectively operate the powered adjustment device with power from the energy storage unit,
   an apparatus controller in electrical communication with the powered adjustment device, the apparatus energy storage unit, and the apparatus user interface, and
   an apparatus interface in communication with the apparatus controller, the apparatus interface including a transmit element to facilitate wireless power transfer; and
a powered device including:
   a module to perform a powered function,
   a device energy storage unit,
   a device user interface arranged for user engagement to selectively operate the module with power from the device energy storage unit,
   a device interface including a receive element, the device interface in communication with the device controller and adapted to cooperate with the apparatus interface to facilitate wireless power transfer between the patient transport apparatus and the powered device, and
   a device controller in electrical communication with the module, the device energy storage unit, and the device user interface, the device controller including a power module configured to determine a charging level for the device energy storage unit based on a current state of the apparatus energy storage unit, and to wirelessly draw power from the apparatus energy storage unit via the apparatus interface and across the device interface to charge the device energy storage unit at the charging level.

XXIII. A patient support system comprising:
a patient transport apparatus including:
   a base including a base frame arranged for movement about floor surfaces, an intermediate frame to provide support to a patient, a base lift device to adjust a height of the intermediate frame relative to the base frame, and a base energy storage unit,
   a litter adapted for releasable attachment to the intermediate frame of the patient transport apparatus, the litter including a litter energy storage unit and a plurality of articulable assemblies defining a patient support surface,
   a litter controller in electrical communication with the litter lift device and the litter energy storage unit,
   a base controller in electrical communication with the base lift device and the base energy storage unit,
   a base interface in communication with the base controller, and
   a litter interface in communication with the litter controller, the litter interface adapted to cooperate with the base interface to facilitate power transfer from the base energy storage unit to the litter energy storage unit; and
a powered device including:
   a module to perform a powered function,
   a device energy storage unit,
   a device interface in communication with the device controller, the device interface adapted to cooperate with at least one of the base interface and the litter interface to facilitate power transfer from at least one of the base energy storage unit and the litter energy storage unit to the device energy storage unit, and
   a device controller in electrical communication with the module and the device energy storage unit, the device controller including a power module configured to determine a charging level for the device energy storage unit based on a current state of at least one of the base energy storage unit and the litter energy storage unit, and to draw power from at least one of the base energy storage unit and the litter energy storage unit and across the device interface to charge the device energy storage unit at the charging level.

XXIV. A patient support system for managing power allocation, the patient support system comprising:
a powered device including:
   a module to perform a powered function,
   a device energy storage unit,
   a device user interface arranged for user engagement to selectively operate the module with power from the device energy storage unit,
   a device controller in electrical communication with the module, the device energy storage unit, and the device user interface, and
   a device interface in communication with the device controller; and
a patient transport apparatus including:
   a base frame arranged for movement about floor surfaces,
   an intermediate frame to provide support to a patient,
   a powered adjustment device,
   an apparatus energy storage unit,
   an apparatus user interface arranged for user engagement to selectively operate the powered adjustment device with power from the energy storage unit,
   an apparatus interface in communication with the apparatus controller, the apparatus interface adapted to cooperate with the device interface to facilitate power transfer from the apparatus energy storage unit to the device energy storage unit, and
   an apparatus controller in electrical communication with the device controller, the apparatus controller including a priority module configured to determine a priority level associated with the powered device, the priority level dictating whether the powered device receives power from the patient transport apparatus, and with the priority module being further configured to transfer power from the apparatus energy storage unit via the apparatus interface and across the device interface to charge the device energy storage unit based on the priority level.

XXV. The patient support system of clause XXIV, wherein the apparatus controller is further configured to allow the powered device to receive power from the patient transport apparatus in response to the priority level being at a first priority level; and to delay power transmission to the powered device in response to the priority level being at a second priority level.

XXVI. The patient support system of any of clauses XXIV-XXV, wherein the apparatus controller is further configured to allow the powered device to receive power from the patient transport apparatus in response to the priority level being at a first priority level; to delay power transmission to the powered device in response to the priority level being at a second priority level; and to restrict power transmission to the powered device in response to the priority level being at a third priority level.

XXVII. The patient support system of clause XXVI, further comprising a patient condition module configured to generate a patient condition signal indicating changes in patient condition; and wherein the apparatus controller is disposed in communication with the patient condition module and configured to determine the priority level at least partially based on to the patient condition; and
wherein the apparatus controller is further configured to modify the priority level associated with the powered device from the second or third priority levels to the first priority level based on the patient condition signal.

XXVIII. The patient support system of clause XXVII, wherein the apparatus controller is further configured to modify the priority level associated with the powered device from the first priority level to the second or third priority levels based on the patient condition signal.

XXIX. The patient support system of any of clauses XXVII-XXVIII, wherein the apparatus controller is further configured to modify the priority level associated with the powered device from the second priority level to the third priority level based on the patient condition signal.

XXX. The patient support system of any of clauses XXIV-XXIX, wherein the apparatus controller is further configured distribute power transferred from the apparatus energy storage unit to the powered device based on at least one of a current state of the apparatus energy storage unit and the priority level associated with the powered device.

XXXI. The patient support system of clause XXX, wherein the apparatus controller is further configured to re-distribute the power transferred from the apparatus energy storage unit to the powered device based at least partially on changes in the priority level associated with the powered device and the current state of the apparatus energy storage unit.

XXXII. The patient support system of clause XXXI, wherein the current state of the apparatus energy storage unit includes a current output level; and
wherein the power module is further configured to:
   determine a maximum output level of the apparatus energy storage unit,
   calculate an available output level based the difference between the maximum output level and the current output level, and
   adjust the power transferred from the apparatus energy storage unit via the apparatus interface based on the available output level of the apparatus energy storage unit and the priority level associated with the powered device.

XXXIII. The patient support system of any of clauses XXIV-XXXII, wherein the apparatus controller and the device controller each include respective wireless subsystems and respective wireless communication modules operable to wirelessly transfer data and to provide, through the wireless communication modules, wireless communication between the patient transport apparatus and the powered device.

XXXIV. The patient support system of clause XXXIII, wherein the apparatus controller includes an authorization module configured to:
receive authorization information from the powered device via the wireless communication module, the authorization information relating to whether the powered device has permission to receive power from the patient transport apparatus;
compare the authorization information relative to a predetermined authorization criterion; and
modify the priority level based on the comparison of the authorization information relative to the predetermined authorization criterion.

XXXV. The patient support system of any of clauses XXIV-XXXIV, wherein the apparatus interface includes a transmit coil and the device interface includes a receive coil, wherein the transmit coil and the receive coil are adapted to cooperate to facilitate power transfer from the apparatus energy storage unit to the device energy storage unit.

XXXVI. A patient support system for managing power allocation, the patient support system comprising:
a first powered device including:
   a first module to perform a powered function,
   a first device energy storage unit,
   a first device user interface arranged for user engagement to selectively operate the first module with power from the first device energy storage unit,
   a first device controller in electrical communication with the first module, the first device energy storage unit, and the first device user interface,
   a first device interface in communication with the first device controller;
a second powered device including:
   a second module to perform a powered function,
   a second device energy storage unit,
   a second device user interface arranged for user engagement to selectively operate the second module with power from the second device energy storage unit,
   a second device controller in electrical communication with the second module, the second device energy storage unit, and the second device user interface,
   a second device interface in communication with the second device controller; and
a patient transport apparatus including:
   a base frame arranged for movement about floor surfaces,
   an intermediate frame to provide support to a patient,
   a powered adjustment device to adjust a height of the intermediate frame relative to the base frame,
   an apparatus energy storage unit,
   an apparatus user interface arranged for user engagement to selectively operate the powered adjustment device with power from the energy storage unit,
   an apparatus interface in communication with the apparatus controller, the apparatus interface adapted to cooperate with the device interface to facilitate power transfer from the apparatus energy storage unit to the device energy storage unit, and
   an apparatus controller in electrical communication with the device controller, the apparatus controller including a priority module configured to determine respective priority levels associated with the first and second powered devices, the priority levels dictating whether the first and second powered devices respectively receive power from the patient transport apparatus, and to transfer power from the apparatus energy storage unit via the apparatus interface and across the first and second device interfaces to respectively charge the first and second device energy storage units based on the respective priority levels of the first and second powered devices.

XXXVII. The patient support system of clause XXXVI, wherein the apparatus controller is further configured to allow the powered device to receive power from the patient transport apparatus in response to the priority level being at a first priority level; and to delay power transmission to the powered device in response to the priority level being at a second priority.

XXXVIII. The patient support system of clause XXXVII, wherein the apparatus controller is further configured to delay, for a predetermined time, transferring power from the apparatus energy storage unit via the apparatus interface to the first powered device with the second priority level.

XXXIX. The patient support system of any of clauses XXXVI-XXXVIII, wherein the apparatus controller is further configured to allow the powered device to receive power from the patient transport apparatus in response to the priority level being at a first priority level; to delay power transmission to the powered device in response to the priority level being at a second priority level; and to restrict power transmission to the powered device in response to the priority level being at a third priority level.

XL. The patient support system of clause XXXIX, wherein the apparatus controller is further configured to prioritize transferring power to the first powered device and the second powered device based on respective priority levels, wherein the first priority level has a higher priority level than the second and third priority levels.

XLI. The patient support system of any of clauses XXXVI-XL, wherein the apparatus controller is further configured to modify the priority level associated with the first powered device and the second powered device based on a current state of the apparatus energy storage unit.

XLII. The patient support system of any of clauses XXXVI-XLII, further comprising a patient condition module configured to generate a patient condition signal indicating changes in patient condition; and wherein the apparatus controller is disposed in communication with the patient condition module and configured to determine the priority level at least partially based on to the patient condition; and
wherein the apparatus controller is further configured to modify the priority level associated with the first powered device and the second powered device based on the patient condition.

XLIII. The patient support system of clause XLII, wherein the apparatus controller is further configured to modify the priority level associated with the first powered device and the second powered device to the first priority level in response to the patient condition signal.

XLIV. The patient support system of any of clauses XXXVI-XLIII, wherein the apparatus controller, the first device controller, and the second device controller each include respective wireless subsystems and respective wireless communication modules operable to wirelessly transfer data and to provide, through the wireless communication modules, wireless communication between the patient transport apparatus and the first and second powered devices.

XLV. The patient support system of clause XLIV, wherein the apparatus controller includes an authorization module configured to:
receive respective authorization information from the first powered device and the second powered device via the wireless communication module, the respective authorization information relating to whether the first and second powered devices have permission to receive power from the patient transport apparatus;
compare the respective authorization information relative to a predetermined authorization criterion; and
modify the priority level associated with the first powered device and the second powered device based on the comparison of the authorization information relative to the predetermined criterion.

XLVI. The patient support system of any of clauses XXXVI-XLV, wherein the apparatus interface includes a transmit coil; the first device interface includes a first receive coil; and the second device interface includes a second receive coil,
wherein the transmit coil and at least one of the first receive coil and the second receive coil are positioned within inductive proximity to each other.

XLVII. The patient support system of any of clauses XXXVI-XLVI, wherein the first powered device is further defined as a litter adapted for releasable attachment to the intermediate frame of the patient transport apparatus, the litter including a plurality of articulable assemblies defining a patient support surface; and
wherein the second powered device is further defined as an accessory device configured to removably couple to the patient transport apparatus.

XLVIII. The patient support system of clause XLVII, further comprising a patient condition module configured to generate a patient condition signal indicating changes in patient condition; and wherein the apparatus controller is disposed in communication with the patient condition module and configured to determine the priority level at least partially based on to the patient condition.

XLIX. The patient support system of clause XLVIII, wherein the apparatus controller is further configured to modify the priority level associated with the accessory device from the first priority level to the second priority level based on the patient condition.

L. The patient support system of any of clauses XXXVI-XLIX, wherein the apparatus controller is further configured to modify the priority level associated with the first powered device based on the priority level associated with the second powered device.

LI. A patient support system for managing power allocation, the patient support system comprising:
a powered device including:
   a module to perform a powered function,
   a device energy storage unit,
   a device controller in electrical communication with the module and the device energy storage unit, and
   a device interface in communication with the device controller; and
a patient transport apparatus including:
   a base including a base frame arranged for movement about floor surfaces, an intermediate frame to provide support to a patient, a base lift device to adjust a height of the intermediate frame relative to the base frame, and a base energy storage unit,
   a litter adapted for releasable attachment to the intermediate frame of the patient transport apparatus, the litter including a litter energy storage unit, a litter lift device, and a plurality of articulable assemblies defining a patient support surface,
   an apparatus controller including a litter controller in electrical communication with the litter lift device and the litter energy storage unit,
   a base controller in electrical communication with the base lift device and the base energy storage unit,
   a base interface in communication with the base controller, and
   a litter interface in communication with the litter controller, the litter interface adapted to cooperate with the base interface to facilitate power transfer from the base energy storage unit to the litter energy storage unit,
   wherein the apparatus controller is in electrical communication with the device controller, the apparatus controller including a priority module configured to determine respective priority levels for the powered device, the base lift device, and the litter lift device, the priority levels dictating whether the powered device, the base lift device, and the litter lift device respectively receive power from the base energy storage unit, and to transfer power to each of the powered device, the base lift device, and the litter lift device based on the respective priority levels.

LII. The patient support system of clause LI, further comprising a patient condition module configured to generate a patient condition signal indicating changes in patient condition; and wherein the apparatus controller is disposed in communication with the patient condition module and configured to determine the priority level at least partially based on to the patient condition; and
wherein the apparatus controller is further configured to modify the priority level associated with the powered device, the base lift device, and the litter lift device based on the patient condition.

LIII. The patient support system of any of clauses LI-LII, wherein the apparatus controller is further configured to modify respective priority levels for the powered device, the base lift device, and the litter lift device in the event the patient condition changes.

LIV. The patient support system of any of clauses LI-LIII, wherein the apparatus controller is further configured to limit power transmission to the powered device, the base lift device, and the litter device based on a predetermined number.

LV. A patient support system comprising:
a powered device including:
   a module to perform a powered function,
   a device energy storage unit,
   a device user interface arranged for user engagement to selectively operate the module with power from the device energy storage unit,
   a device controller in electrical communication with the module, the device energy storage unit, and the device user interface, and
   a device interface in communication with the device controller; and
a patient transport apparatus including:
   a base frame arranged for movement about floor surfaces,
   an intermediate frame to provide support to a patient,
   a powered adjustment device to adjust a height of the intermediate frame relative to the base frame,
   an apparatus energy storage unit,
   an apparatus user interface arranged for user engagement to selectively operate the powered adjustment device with power from the energy storage unit,
   an apparatus interface in communication with the apparatus controller, the apparatus interface adapted to cooperate with the device interface to facilitate power transfer from the apparatus energy storage unit to the device energy storage unit, and
   an apparatus controller in electrical communication with the device controller, the apparatus controller including an identification module configured to receive identity data from the powered device, to identify the powered device based on the identity data, and to transfer power from the apparatus energy storage unit via the apparatus interface and across the device interface to charge the device energy storage unit based on the identity data.

LVI. The patient support system of clause LV, wherein the identification module is further configured to determine an identification profile associated with the powered device based on the identity data.

LVII. The patient support system of clause LVI, wherein the apparatus controller is further configured to at least partially limit the transfer of power from the patient transport apparatus to the powered device based on the identification profile of the powered device.

LVIII. The patient support system of any of clauses LV-LVII, wherein the device controller includes a power module configured to determine a charging level for the device energy storage unit based on a current state of the apparatus energy storage unit, and wherein the power module is further configured to draw power from the apparatus energy storage unit via the apparatus interface and across the device interface to charge the device energy storage unit at the charging level.

LIX. The patient support system of clause LVIII, wherein the current state of the apparatus energy storage unit includes a current output level; and
wherein the power modules is further configured to:
   determine a maximum output level of the apparatus energy storage unit,
   calculate an available output level based the difference between the maximum output level and the current output level, and
   adjust the power drawn from the apparatus energy storage unit via the apparatus interface based on the available output level of the apparatus energy storage unit.

LX. The patient support system of any of clauses LV-LIX, wherein the apparatus controller and the device controller each include respective wireless subsystems and respective wireless communication modules operable to wirelessly transfer data and to provide, through the wireless communication modules, wireless communication between the patient transport apparatus and the powered device.

LXI. The patient support system of clause LX, wherein the respective wireless subsystems are further defined as respective controller area network (CAN) subsystems.

LXII. The patient support system of any of clauses LX-LXI, wherein the respective wireless communication modules are configured to operate according to a Bluetooth Low Energy (BLE) protocol.

LXIII. The patient support system of clause LXII, wherein the device controller is further configured to wirelessly transmit the identity data of the powered device to the apparatus controller according to the BLE protocol.

LXIV. The patient support system of any of clauses LVI-LXIII, wherein the device controller is further configured to wirelessly transmit at least a portion of the identification profile of the powered device from the device controller to the apparatus controller.

LXV. The patient support system of clause LX, wherein the device controller includes a feedback module configured to provide feedback upon detection of changes related to the powered device and to wirelessly transmit the identity data to the apparatus controller via the respective wireless communication modules based on the feedback.

LXVI. The patient support system of clause LXV, wherein the feedback module is configured to detect changes in a field generated between the respective wireless subsystems, and to initiate transmission of the identity data to the apparatus controller based on predetermined changes detected in the field.

LXVII. The patient support system of clause LXVI, wherein the apparatus interface includes a transmit coil generating the field and the device interface includes a receive coil, and wherein interaction of the receive coil with the field at least partially changes the field based on proximity between the transmit coil and the receive coil.

LXVIII. The patient support system of any of clauses LXV-LXVII, wherein the feedback module is configured to detect positional changes of the powered device relative to the patient transport apparatus, to initiate a proximity pairing process between the powered device and the patient transport apparatus in response to determining that the wireless communication module of the powered device is within a predetermined proximity of the wireless communication module of the patient transport apparatus, and to transmit a pairing signal including the identity data.

LXIX. The patient support system of clause LXVIII, wherein the apparatus controller is further configured to receive the pairing signal and to determine whether to connect the powered device to the patient transport apparatus based on the pairing signal.

LXX. A patient support system for managing power allocation, the patient support system comprising:
a first powered device including:
   a first module to perform a powered function,
   a first device energy storage unit,
   a first device user interface arranged for user engagement to selectively operate the first module with power from the first device energy storage unit,
   a first device controller in electrical communication with the first module, the first device energy storage unit, and the first device user interface,
   a first device interface in communication with the first device controller;
a second powered device including:
   a second module to perform a powered function,
   a second device energy storage unit,
   a second device user interface arranged for user engagement to selectively operate the second module with power from the second device energy storage unit,
   a second device controller in electrical communication with the second module, the second device energy storage unit, and the second device user interface,
   a second device interface in communication with the second device controller; and
a patient transport apparatus including:
   a base frame arranged for movement about floor surfaces,
   an intermediate frame to provide support to a patient,
   a powered adjustment device to adjust a height of the intermediate frame relative to the base frame,
   an apparatus energy storage unit,
   an apparatus user interface arranged for user engagement to selectively operate the powered adjustment device with power from the energy storage unit,
   an apparatus interface in communication with the apparatus controller, the apparatus interface adapted to cooperate with the device interface to facilitate power transfer from the apparatus energy storage unit to the device energy storage unit, and
   an apparatus controller in electrical communication with the device controller, the apparatus controller including an identification module configured to receive respective identity data from the first and second powered devices, to determine respective identification profiles associated with the first and second powered devices, and to control the transfer of power between the patient transport apparatus and one or more of the first powered device and the second powered device based on the respective identify data received from the first and second powered devices.

LXXI. The patient support system of clause LXX, wherein the apparatus controller, the first device controller, and the second device controller each include respective wireless subsystems and respective wireless communication modules operable to wirelessly transfer data and to provide, through the wireless communication modules, wireless communication between the patient transport apparatus and the first and second powered devices.

LXXII. The patient support system of clause LXXI, wherein the apparatus controller is further configured to at least partially limit the transfer of power from the patient transport apparatus to the first powered device and the second powered device based on the identification profile associated with the first powered device and the second powered device.

LXXIII. The patient support system of any of clauses LXXI-LXXII, wherein the apparatus interface includes a transmit coil, the first device interface includes a first receive coil, and the second device interface includes a second receive coil, wherein the transmit coil and at least one of the first receive coil and the second receive coil are positioned within inductive proximity to each other.

LXXIV. The patient support system of any of clauses LXX-LXXIII, wherein the first and second device controllers each include respective feedback modules configured to provide feedback upon detection of changes related to the first and second powered devices and to wirelessly transmit the respective identity data to the apparatus controller via the respective wireless communication modules.

LXXV. The patient support system of clause LXXIV, wherein the feedback module is configured to detect positional changes of the first powered device and the second powered device relative to the patient transport apparatus, to initiate a proximity pairing process between at least one of the first powered device and second powered device and the patient transport apparatus in response to determining that the wireless communication module of at least one of the first powered device and the second powered device is within a predetermined proximity of the wireless communication module of the patient transport apparatus, and to transmit a pairing signal including the identity data to at least one of the first powered device and the second powered device.

LXXVI. The patient support system of clause LXXV, wherein the apparatus controller is further configured to receive the pairing signal and to determine whether to connect at least one of the first powered device and the second powered device to the patient transport apparatus based on the pairing signal.

LXXVII. The patient support system of any of clauses LXX-LXXVI, wherein the identification module is further configured to limit power transmission to the first powered device and the second powered device based on a predetermined number.

LXXVIII. A patient support system comprising:
a powered device including:
   a module to perform a powered function,
   a device energy storage unit,
   a device controller in electrical communication with the module and the device energy storage unit, and
   a device interface in communication with the device controller; and
a patient transport apparatus including:
   a base including a base frame arranged for movement about floor surfaces, an intermediate frame to provide support to a patient, a base lift device to adjust a height of the intermediate frame relative to the base frame, and a base energy storage unit,
   a litter adapted for releasable attachment to the intermediate frame of the patient transport apparatus, the litter including a litter energy storage unit, a litter lift device, and a plurality of articulable assemblies defining a patient support surface,
   an apparatus controller including a litter controller in electrical communication with the litter lift device, and the litter energy storage unit,
   a base controller in electrical communication with the base lift device and the base energy storage unit,
   a base interface in communication with the base controller, and
   a litter interface in communication with the litter controller, the litter interface adapted to cooperate with the base interface to facilitate power transfer from the base energy storage unit to the litter energy storage unit,
   wherein the apparatus controller is in electrical communication with the device controller and includes an identification module configured to receive identity data from the powered device, to identify the powered device based on the identity data, to determine an identification profile associated with the powered device based on the identity data, and to transfer power from the apparatus energy storage unit via the apparatus interface and across the device interface to charge the device energy storage unit based on the identity data.

1. A patient support system comprising:
a patient transport apparatus including:
a base frame arranged for movement about floor surfaces,
an intermediate frame to provide support to a patient,
a powered adjustment device,
an apparatus energy storage unit,
an apparatus user interface arranged for user engagement to selectively operate the powered adjustment device with power from the energy storage unit,
an apparatus controller in electrical communication with the powered adjustment device, the apparatus energy storage unit, and the apparatus user interface, and
an apparatus interface in communication with the apparatus controller; and
a powered device including:
a module to perform a powered function,
a device energy storage unit,
a device user interface arranged for user engagement to selectively operate the module with power from the device energy storage unit,
a device interface in communication with the device controller, the device interface adapted to cooperate with the apparatus interface to facilitate power transfer from the apparatus energy storage unit to the device energy storage unit, and
a device controller in electrical communication with the module, the device energy storage unit, and the device user interface, the device controller including a power module configured to determine a charging level for the device energy storage unit based on a current state of the apparatus energy storage unit, and to draw power from the apparatus energy storage unit via the apparatus interface and across the device interface to charge the device energy storage unit at the charging level.

2. The patient support system of claim 1, wherein the apparatus interface includes a transmit element and the device interface includes a receive element to facilitate power transfer between the patient transport apparatus and the powered device.

3. The patient support system of claim 2, wherein the transmit element is further defined as a transmit coil and the receive element is further defined as a receive coil, the transmit coil and the receive coil are adapted to cooperate to facilitate supplying power from the patient transport apparatus to the powered device.

4. The patient support system of claim 1, wherein the current state of the apparatus energy storage unit includes a current output level; and
wherein the power module is further configured to:
determine a maximum output level of the apparatus energy storage unit, calculate an available output level based the difference between the maximum output level and the current output level, and
adjust the power drawn from the apparatus energy storage unit from the apparatus interface based on the available output level of the apparatus energy storage unit.

5. The patient support system of claim 1, wherein the apparatus controller is disposed in electrical communication with the device controller; and
wherein the apparatus controller is further configured to monitor the current state of the apparatus energy storage unit, and to transmit the current state to the power module of the device controller.

6. The patient support system of claim 1, wherein the powered device is further defined as an accessory device configured to removably couple to the patient transport apparatus.

7. The patient support system of claim 1, wherein the powered adjustment device is further defined as a base lift device configured to adjust a height of the intermediate frame relative to the base frame.

8. The patient support system of claim 6, wherein the apparatus interface includes a transmit element and the device interface includes a receive element to facilitate power transfer between the patient transport apparatus and the accessory device.

9. The patient support system of claim 1, wherein the powered device is further defined as a litter adapted for releasable attachment to the intermediate frame of the patient transport apparatus, the litter including a plurality of articulable assemblies defining a patient support surface.

10. The patient support system of claim 9, wherein the apparatus interface includes a transmit element and the device interface of the litter includes a receive element to facilitate power transfer between the patient transport apparatus and the litter.

11. The patient support system of claim 10, wherein the transmit element is operatively attached to the intermediate frame and is arranged for alignment with the receive element; and
wherein the transmit element is further defined as a transmit coil and the receive element is further defined as a receive coil, the transmit coil and the receive coil are adapted to cooperate such that power may be supplied from the patient transport apparatus to the powered device.

12. The patient support system of claim 1, wherein the apparatus controller is disposed in electrical communication with the device controller; and
wherein the powered device further includes:
a wireless subsystem in electrical communication with the device controller, and a wireless communication module operable to wirelessly transfer data and to provide, through the wireless communication module, wireless communication between the device controller and the apparatus controller.

13. The patient support apparatus of claim 12, wherein the wireless subsystem is further defined as a controller area network (CAN) subsystem.

14. The patient support apparatus of claim 13, wherein the wireless communication module is configured to operate according to a Bluetooth Low Energy (BLE) protocol.

15. A patient support system comprising:
a patient transport apparatus including:
a base frame arranged for movement about floor surfaces,
an intermediate frame to provide support to a patient, a powered adjustment device,
an apparatus energy storage unit,
an apparatus user interface arranged for user engagement to selectively operate the powered adjustment device with power from the energy storage unit,
an apparatus controller in electrical communication with the powered adjustment device, the apparatus energy storage unit, and the apparatus user interface, and
an apparatus interface in communication with the apparatus controller;
a first powered device including:
a first module to perform a powered function,
a first device energy storage unit, a first device user interface arranged for user engagement to selectively operate the first module with power from the first device energy storage unit,
a first device interface in communication with the first device controller, the first device interface adapted to cooperate with the apparatus interface to facilitate power transfer from the apparatus energy storage unit to the first device energy storage unit, and a first device controller in electrical communication with the first module, the first device energy storage unit, and the first device user interface; and
a second powered device including:
a second module to perform a powered function, a second device energy storage unit, a second device user interface arranged for user engagement to selectively operate the second module with power from the second device energy storage unit,
a second device interface in communication with the second device controller, the second device interface adapted to cooperate with the apparatus interface to facilitate power transfer from the apparatus energy storage unit to the second device energy storage unit, and
a second device controller in electrical communication with the second module, the second device energy storage unit, and the second device user interface,
wherein the first device controller includes a first power module configured to determine a first charging level for the first powered device based on a current state of the apparatus energy storage unit, and to draw power from the apparatus energy storage unit via the apparatus interface and across the first device interface to charge the first energy storage unit at the first charging level, wherein the second device controller includes a second power module configured to determine a second charging level for the second powered device based on the current state of the apparatus energy storage unit, and to draw power from the apparatus energy storage unit via the apparatus interface and across the second device interface to charge the second energy storage unit at the second charging level.

16. The patient support system of claim 15, wherein the apparatus interface includes a transmit element, the first device interface includes a first receive element, and the second device interface includes a second receive element, wherein the transmit element and the first and second receive elements are configured to facilitate power transfer between the patient transport apparatus and the first and second powered devices, respectively.

17. The patient support system of claim 16, wherein the transmit element and at least one of the first receive element and the second receive element are adapted to cooperate such that power may be supplied from the patient transport apparatus to the first and second powered devices.

18. The patient support system of claim 16, wherein the apparatus interface includes a second transmit element, different from the first transmit element, to transfer power independent of the first transmit element.

19. The patient support system of claim 15, wherein the current state of the apparatus energy storage unit includes a current output level; and
wherein the first and second power modules are further configured to:
determine a maximum output level of the apparatus energy storage unit, calculate an available output level based the difference between the maximum output level and the current output level,
adjust the power drawn from the apparatus energy storage unit from the apparatus interface based on the available output level of the apparatus energy storage unit.

20. The patient support system of claim 19, wherein the apparatus controller is configured to distribute the power between the first and second powered devices based on the available output level of the apparatus energy storage unit.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)
